(19) United States
(12) Patent Application Publication
(10) Pub. No.: US 2017/0132714 A1
(43) Pub. Date: May 11, 2017

(54) TAGGING COMMUNICATION DATA

(71) Applicant: JKP Tech Pty Ltd, Mount Claremont (AU)

(72) Inventor: Robert William ADAMS, Mount Claremont (AU)

(21) Appl. No.: 15/325,973

(22) PCT Filed: Jul. 17, 2015
(86) PCT No.: PCT/AU2015/000420

§ 371 Date: Jan. 12, 2017

(30) Foreign Application Priority Data
Jul. 17, 2014 (AU) 2014902765

(51) Int. Cl. G06Q 40/00; H04W 4/24; H04M 15/00; G06Q 30/04; G06F 17/30

(52) U.S. Cl. CPC G06Q 40/10; G06Q 30/04; G06F 17/30876; G06F 17/30864; H04M 15/41; H04M 15/43; H04M 15/62; H04W 4/24

(57) ABSTRACT

Method for the tagging mobile communication data with an electronic tag which signifies the association of call data with a taxation category. The call data and tag data association is used within a billing system to allocated usage charges between personal and business calls. Wherein a default electronic tag is associated with call data for that has not been previously categorized. The billing system produces a financial report using the stored data. The stored data can be accessed through a web portal.

### TECHNICAL FIELD

The present invention relates generally to a communication tracking method and system. In particular, the present invention relates to a mobile communication device implemented method, a mobile communication device and a computing system for tagging communication related data.

### BACKGROUND

Users of mobile telephone devices may own a single mobile telephone device that is used for both work and personal purposes. This reduces the need for that person to carry two separate mobile telephone devices or to purchase a mobile telephone that has dual SIM functionality.

However, a problem may occur where the user wishes to allocate calls as work related or personal calls for determining any available tax benefits. Currently, a user must look through their mobile telephone billing data and determine which calls are business related and which are personal in order to calculate a suitable amount for claiming as a business related activity. This can be very time consuming and can result in errors where a user makes hundreds of calls each month. Other financial related details associated with communications made using mobile telephones may also be missed or lost. This can becomes particularly problematic in corporate situations where multiple employees are utilising mobile telephones for both work and personal related communications.

The above problem is further exacerbated when taking into account costs associated with sending SMS communications and data usage associated with emails communications, application usage, internet usage and content downloads.

### SUMMARY OF INVENTION

The present invention aims to substantially overcome, or at least ameliorate, one or more disadvantages of existing arrangements.

According to a first aspect of the present disclosure, there is provided a mobile communication device implemented method for tagging mobile communication related data, wherein the mobile communication related data comprises one or more of: call related data, SMS related data, data usage related data and electronic mail related data, the method comprising the steps of: determining whether a communication had been initiated on a mobile communication device; upon a positive determination that the communication had been initiated, determining whether the communication uses communication related data that has not been previously used by the mobile communication device; and upon a positive determination, automatically applying an electronic tag to the communication related data, wherein the electronic tag associates the communication related data with a tax-related category selected from a plurality of tax-related categories.

According to a further aspect of the present disclosure, there is provided a mobile communication device comprising a processor arranged to: determine whether a communication had been initiated on a mobile communication device; upon a positive determination that the communication had been initiated, determine whether the communication uses communication related data that has not been previously used by the mobile communication device, wherein the communication related data comprises one or more of: call related data, SMS related data, data usage related data and electronic mail related data; and upon a positive determination, automatically apply an electronic tag to the communication related data, wherein the electronic tag associates the communication related data with a tax-related category selected from a plurality of tax-related categories.

According to a further aspect of the present disclosure, there is provided a computer implemented method comprising the steps of: retrieving communication related data that is associated with one or more communications made by at least one mobile communication device within a defined period; wherein the communication data comprises tagged data, wherein the tagged data comprises one or more telephone numbers and/or contacts that were communicated with within the defined period, SMS usage, data usage, and one or more associated electronic tags; wherein the electronic tag associates the telephone numbers and/or contacts with the tagged data; generating at least one financial report for the defined period based on the tagged data; and outputting the generated financial report.

According to a further aspect of the present disclosure, there is provided a computing system comprising a communication interface for communicating with at least one mobile communication device, a database for storing plan data associated with at least one mobile communication device and a processor, wherein the communication interface is arranged to: retrieve communication related data from the database, where the communication related data is associated with one or more communications made by at least one mobile communication device within a defined period, wherein the communication related data comprises tagged data, where the tagged data comprises one or more telephone numbers and/or contacts that were communicated with within the defined period, SMS usage, data usage, and one or more associated electronic tags, wherein the electronic tag associates the telephone numbers and/or contacts with the tagged data and the processor is arranged to at least one financial report for the defined period based on the tagged data, and output the generated financial report.

Software is disclosed for performing the herein described methods. A non-transitory medium is also disclosed for storing the software.

According to a further aspect of the present disclosure, there is provided a mobile communication device comprising a processor, communication interface, memory and display, wherein the memory comprises stored software code that is arranged to execute instructions under control of the processor to enable the processor to perform one or more methods as described herein in conjunction with the communication interface and display.

Other aspects of the invention are also disclosed.

### BRIEF DESCRIPTION OF DRAWINGS

At least one embodiment of the present invention will now be described with reference to the drawings, in which:

FIGS. 1A and 1B show schematic block diagrams of an electronic device according to the herein disclosure;

FIG. 2 shows a schematic block diagram of a computing system network according to the herein disclosure;

FIG. 3 shows a process flow diagram according to the herein disclosure;

FIG. 4 shows a further process flow diagram according to the herein disclosure;

FIG. 5 shows a further process flow diagram according to the herein disclosure;

FIG. 6 shows a further process flow diagram according to the herein disclosure;

FIG. 7 shows a screen shot according to the herein disclosure;

FIG. 8 shows a further screen shot according to the herein disclosure;

FIG. 9 shows a further screen shot according to the herein disclosure;

FIG. 10 shows a further screen shot according to the herein disclosure;

FIG. 11 shows a further screen shot according to the herein disclosure;

FIG. 12 shows a screen shot identifying various elements for calculation purposes according to the herein disclosure;

FIG. 13 shows a further screen shot identifying various elements for calculation purposes according to the herein disclosure;

FIG. 14 shows a further screen shot identifying various elements for calculation purposes according to the herein disclosure;

### DESCRIPTION OF EMBODIMENTS

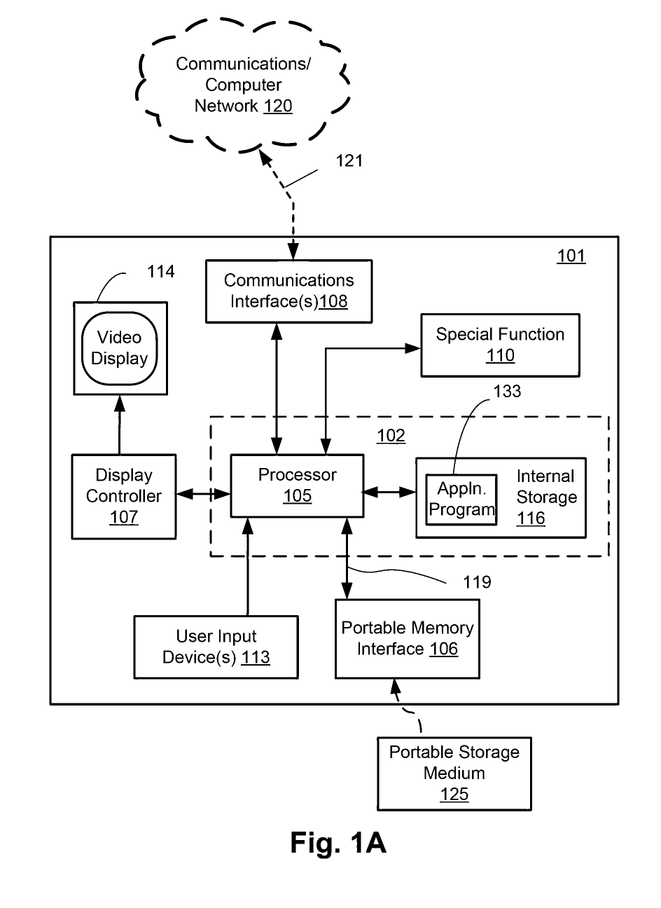

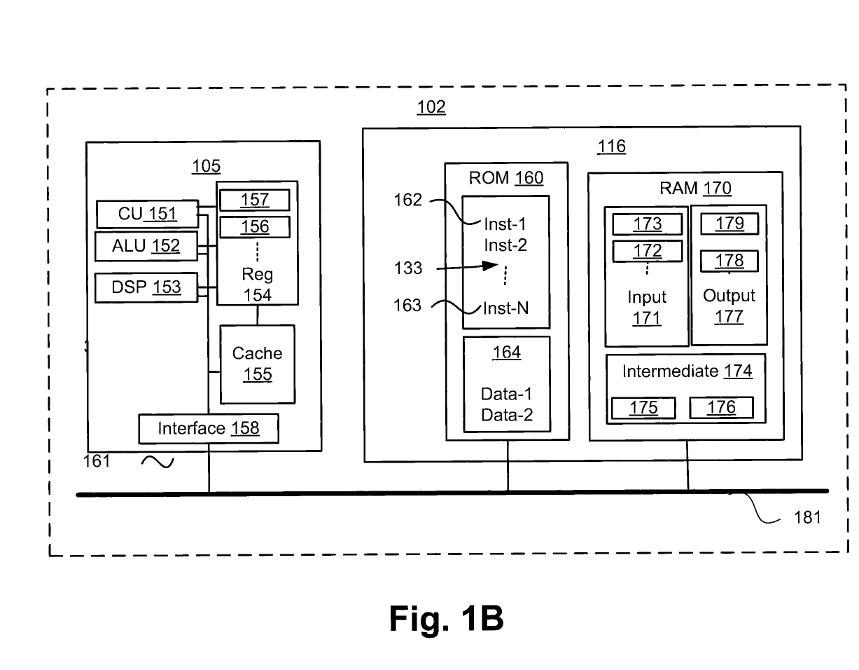

FIGS. 1A and 1B collectively form a schematic block diagram of a general purpose electronic device 101 including embedded components, upon which various methods described herein are desirably practiced. The electronic device 101 may be, for example, a mobile phone or a portable computing device including tablets and laptops in which processing resources are limited. Nevertheless, the methods to be described may also be performed on higher-level devices such as desktop computers, server computers, and other such devices with significantly larger processing resources.

As seen in FIG. 1A, the electronic device 101 comprises an embedded controller 102. Accordingly, the electronic device 101 may be referred to as an “embedded device.” In the present example, the controller 102 has a processing unit (or processor) 105 which is bi-directionally coupled to an internal storage module 109. The storage module 109 may be formed from non-volatile semiconductor read only memory (ROM) 160 and semiconductor random access memory (RAM) 170, as seen in FIG. 1B. The RAM 170 may be volatile, non-volatile or a combination of volatile and non-volatile memory.

The electronic device 101 includes a display controller 107, which is connected to a video display 114, such as a liquid crystal display (LCD) panel or the like. The display controller 107 is configured for displaying graphical images on the video display 114 in accordance with instructions received from the embedded controller 102, to which the display controller 107 is connected.

The electronic device 101 also includes user input devices 113 which are typically formed by keys, a keypad or like controls. In some implementations, the user input devices 113 may include a touch sensitive panel physically associated with the display 114 to collectively form a touch-screen. Such a touch-screen may thus operate as one form of graphical user interface (GUI) as opposed to a prompt or menu driven GUI typically used with keypad-display combinations. Other forms of user input devices may also be used, such as a microphone (not illustrated) for voice commands or a joystick/thumb wheel (not illustrated) for ease of navigation about menus.

As seen in FIG. 1A, the electronic device 101 also comprises a portable memory interface 106, which is coupled to the processor 105 via a connection 119. The portable memory interface 106 allows a complementary portable memory device 125 to be coupled to the electronic device 101 to act as a source or destination of data or to supplement the internal storage module 109. Examples of such interfaces permit coupling with portable memory devices such as Universal Serial Bus (USB) memory devices, Secure Digital (SD) cards, Personal Computer Memory Card International Association (PCMIA) cards, optical disks and magnetic disks.

The electronic device 101 also has a communications interface 108 to permit coupling of the device 101 to a computer or communications network 120 via a connection 121. The connection 121 may be wired or wireless. For example, the connection 121 may be radio frequency or optical. An example of a wired connection includes Ethernet. Further, an example of wireless connection includes Bluetooth™ type local interconnection, Wi-Fi (including protocols based on the standards of the IEEE 802.11 family), Infrared Data Association (IrDa) and the like.

Typically, the electronic device 101 is configured to perform some special function. The embedded controller 102, possibly in conjunction with further special function components 110, is provided to perform that special function. The special function components 110 is connected to the embedded controller 102. As another example, the device 101 may be a mobile telephone handset. In this instance, the components 110 may represent those components required for communications in a cellular telephone environment. Where the device 101 is a portable device, the special function components 110 may represent a number of encoders and decoders of a type including Joint Photographic Experts Group (JPEG), (Moving Picture Experts Group) MPEG, MPEG-1 Audio Layer 3 (MP3), and the like.

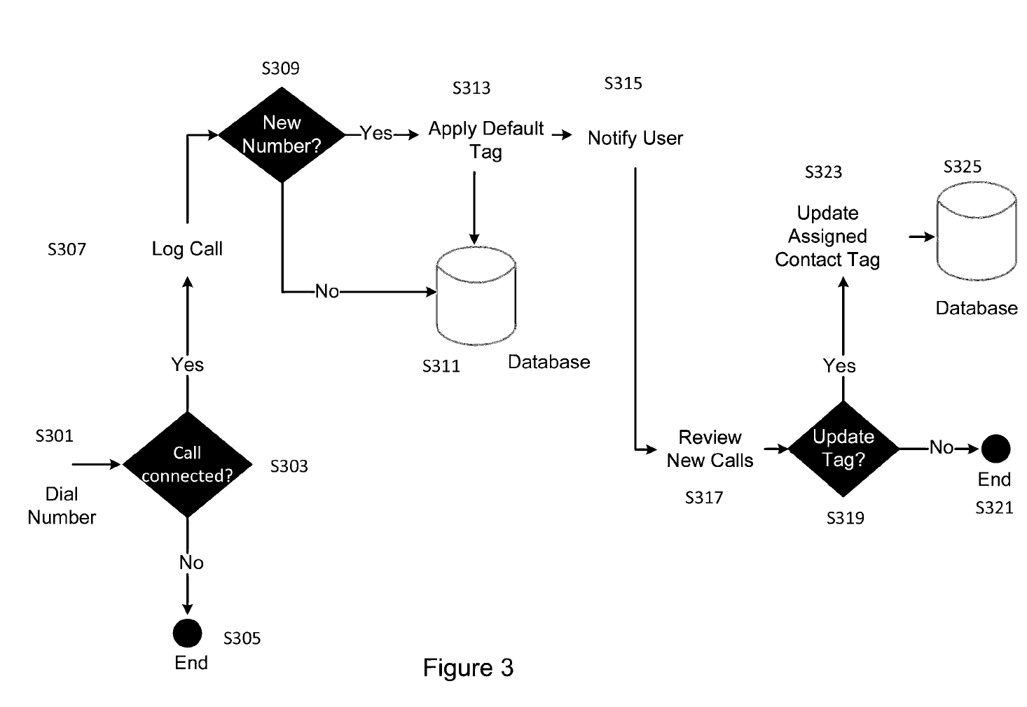

The methods described hereinafter may be implemented using the embedded controller 102, where the process of FIG. 3 may be implemented as one or more software application programs 133 executable within the embedded controller 102. The electronic device 101 of FIG. 1A implements the described methods. In particular, with reference to FIG. 1B, the steps of the described methods are effected by instructions in the software 133 that are carried out within the controller 102. The software instructions may be formed as one or more code modules, each for performing one or more particular tasks. The software may also be divided into two separate parts, in which a first part and the corresponding code modules performs the described methods and a second part and the corresponding code modules manage a user interface between the first part and the user.

The software 133 of the embedded controller 102 is typically stored in the non-volatile ROM 160 of the internal storage module 109. The software 133 stored in the ROM 160 can be updated when required from a computer readable medium. The software 133 can be loaded into and executed by the processor 105. In some instances, the processor 105 may execute software instructions that are located in RAM 170. Software instructions may be loaded into the RAM 170 by the processor 105 initiating a copy of one or more code modules from ROM 160 into RAM 170. Alternatively, the software instructions of one or more code modules may be pre-installed in a non-volatile region of RAM 170 by a manufacturer. After one or more code modules have been located in RAM 170, the processor 105 may execute software instructions of the one or more code modules.

The application program 133 is typically pre-installed and stored in the ROM 160 by a manufacturer, prior to distribution of the electronic device 101. However, in some instances, the application programs 133 may be supplied to the user encoded on one or more CD-ROM (not shown) and read via the portable memory interface 106 of FIG. 1A prior to storage in the internal storage module 109 or in the portable memory 125. In another alternative, the software application program 133 may be read by the processor 105 from the network 120, or loaded into the controller 102 or the portable storage medium 125 from other computer readable media. Computer readable storage media refers to any non-transitory tangible storage medium that participates in providing instructions and/or data to the controller 102 for execution and/or processing. Examples of such storage media include floppy disks, magnetic tape, CD-ROM, a hard disk drive, a ROM or integrated circuit, USB memory, a magneto-optical disk, flash memory, or a computer readable card such as a PCMCIA card and the like, whether or not such devices are internal or external of the device 101. Examples of transitory or non-tangible computer readable transmission media that may also participate in the provision of software, application programs, instructions and/or data to the device 101 include radio or infra-red transmission channels as well as a network connection to another computer or networked device, and the Internet or Intranets including e-mail transmissions and information recorded on Websites and the like. A computer readable medium having such software or computer program recorded on it is a computer program product.

The second part of the application programs 133 and the corresponding code modules mentioned above may be executed to implement one or more graphical user interfaces (GUIs) to be rendered or otherwise represented upon the display 114 of FIG. 1A. Through manipulation of the user input device 113 (e.g., the keypad), a user of the device 101 and the application programs 133 may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers (not illustrated) and user voice commands input via the microphone (not illustrated).

FIG. 1B illustrates in detail the embedded controller 102 having the processor 105 for executing the application programs 133 and the internal storage 109. The internal storage 109 comprises read only memory (ROM) 160 and random access memory (RAM) 170. The processor 105 is able to execute the application programs 133 stored in one or both of the connected memories 160 and 170. When the electronic device 101 is initially powered up, a system program resident in the ROM 160 is executed. The application program 133 permanently stored in the ROM 160 is sometimes referred to as “firmware”. Execution of the firmware by the processor 105 may fulfil various functions, including processor management, memory management, device management, storage management and user interface.

The processor 105 typically includes a number of functional modules including a control unit (CU) 151, an arithmetic logic unit (ALU) 152 and a local or internal memory comprising a set of registers 154 which typically contain atomic data elements 156, 157, along with internal buffer or cache memory 155. One or more internal buses 159 interconnect these functional modules. The processor 105 typically also has one or more interfaces 158 for communicating with external devices via system bus 181, using a connection 161.

The application program 133 includes a sequence of instructions 162 through 163 that may include conditional branch and loop instructions. The program 133 may also include data, which is used in execution of the program 133. This data may be stored as part of the instruction or in a separate location 164 within the ROM 160 or RAM 170.

In general, the processor 105 is given a set of instructions, which are executed therein. This set of instructions may be organised into blocks, which perform specific tasks or handle specific events that occur in the electronic device 101. Typically, the application program 133 waits for events and subsequently executes the block of code associated with that event. Events may be triggered in response to input from a user, via the user input devices 113 of FIG. 1A, as detected by the processor 105. Events may also be triggered in response to other sensors and interfaces in the electronic device 101.

The execution of a set of the instructions may require numeric variables to be read and modified. Such numeric variables are stored in the RAM 170. The disclosed method uses input variables 171 that are stored in known locations 172, 173 in the memory 170. The input variables 171 are processed to produce output variables 177 that are stored in known locations 178, 179 in the memory 170. Intermediate variables 174 may be stored in additional memory locations in locations 175, 176 of the memory 170. Alternatively, some intermediate variables may only exist in the registers 154 of the processor 105.

The execution of a sequence of instructions is achieved in the processor 105 by repeated application of a fetch-execute cycle. The control unit 151 of the processor 105 maintains a register called the program counter, which contains the address in ROM 160 or RAM 170 of the next instruction to be executed. At the start of the fetch execute cycle, the contents of the memory address indexed by the program counter is loaded into the control unit 151. The instruction thus loaded controls the subsequent operation of the processor 105, causing for example, data to be loaded from ROM memory 160 into processor registers 154, the contents of a register to be arithmetically combined with the contents of another register, the contents of a register to be written to the location stored in another register and so on. At the end of the fetch execute cycle the program counter is updated to point to the next instruction in the system program code. Depending on the instruction just executed this may involve incrementing the address contained in the program counter or loading the program counter with a new address in order to achieve a branch operation.

Each step or sub-process in the processes of the methods described below is associated with one or more segments of the application program 133, and is performed by repeated execution of a fetch-execute cycle in the processor 105 or similar programmatic operation of other independent processor blocks in the electronic device 101.

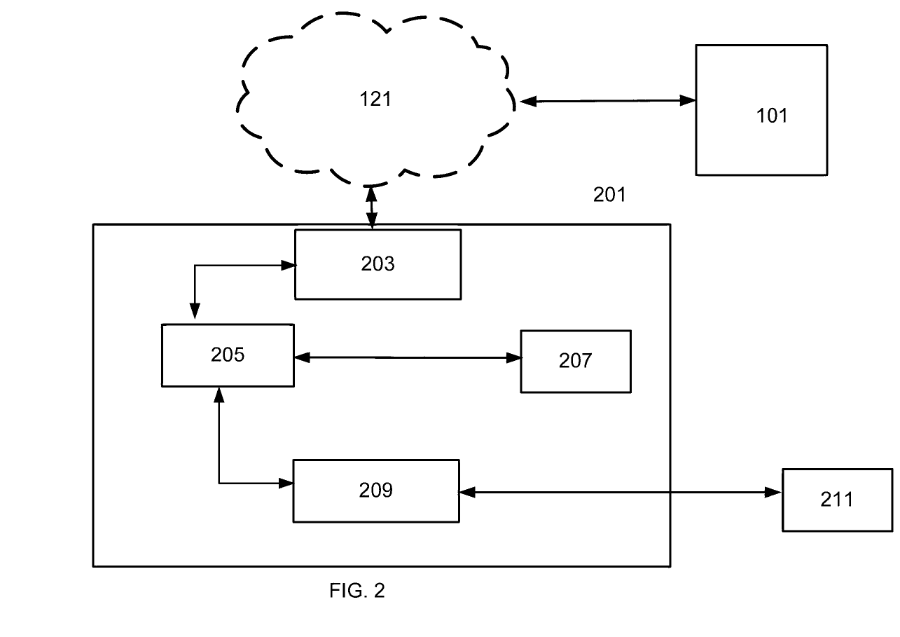

FIG. 2 shows a system block diagram including the electronic device 101 described in FIGS. 1A and 1B connected to a computer system via a communications/computer network 121.

The computer system includes a web service portal 201 that is in communication with the communications/computer network 121. The portal includes a web server that communicates and serves a web page to the Internet. The server is an HTTP based web server that has an application programming interface (API) 203 for communicating with other devices, including the electronic device 101, via a published web page. The portal 201 also receives data via the web page.

Data may be transmitted and shared between connected devices and the portal via the API. For example, the electronic device 101 may connect to a web page via a URL entered into the browser of the electronic device 101. The web page will be displayed on the screen of the electronic device enabling the user of the electronic device 101 to enter data via the user input devices 113 of the electronic device as well as receive data from the portal 201.

The portal 201 has a processor 205 that handles instructions being sent to and from the portal 201 via the web page. An internal memory 207 is used to temporarily store instructions and data within the portal 201 as well as storing software that provides instructions for execution by the processor 205 in the same way as that described above in relation to the electronic device 101.

The portal 201 also has an I/O interface 209 for interfacing with other external devices, such as an external database 211. The external database 211 operates using database software for storing data therein and enabling the portal to retrieve data. It will be understood that any suitable database querying language may be used for entering and manipulating data within the database.

FIG. 3 shows a process that occurs between a user of a mobile telephone and the software application program (an “App”) that is stored and executed on that mobile telephone. The App is executed under the control of the processor on the mobile telephone.

At step S301 a user attempts to call a number using the user interface of the mobile telephone to connect to another mobile telephone. For example, the user may either enter a number using a keypad on the telephone or may access a telephone number via the contacts directory of the mobile telephone.

Upon detecting the end of a call being made on the mobile telephone by detecting the end of call trigger, the mobile telephone processor determines whether a call had been initiated. That is, at the end of a call, the App on the mobile telephone enables the processor to determine whether a call had been initiated by determining whether the call was connected between the user's mobile telephone and another mobile telephone for a minimum predetermined period of time. For example, the processor determines whether the call to the other mobile telephone had a duration of at least one second. If the duration is less than one second, the processor in the mobile telephone determines that a call had not been connected and the process ends at step S305. Therefore, calls that are made with a duration of 1 second or greater are logged by the App.

It will be understood that other time periods may be used to determine whether a call was initiated or not. For example, time durations of less or more than one second may be used to determine if a call had been initiated.

If the processor in the mobile telephone determines that a call had been connected (i.e. initiated) at step S303 the call is then logged at step S307. The logging of the call includes storing the details of the telephone number called and contact along with the duration and time of the call into the internal memory of the mobile telephone.

It will also be understood that the mobile telephone may also determine whether an SMS has been initiated or whether data transfer has been initiated.

At step S309 the processor determines whether the number that has just been dialed is a new number being used on the mobile telephone. The software application program determines this by searching the log details stored on the mobile telephone to determine if that mobile telephone has previously been logged by the software application program. If a log count of greater than 0 is assigned to that telephone number, then a determination is made that the telephone number is not new. Whereas, if a log count of 0 is assigned, or no log exists, a determination is made that the telephone number is new.

It will also be understood that the software application program may also, or instead, search the stored logs to determine if a particular contact associated with a telephone number is new using the same methodology described above.

Further, it will be understood that, as an alternative, the determination of whether a new number has been dialed for the first time may be based on searching the logs in the mobile telephone as opposed to the logs stored by the software application program. For example, a new number may be defined as a number that has been dialed for the first time on that mobile telephone. For example, the new number may be for an existing contact that has been dialed for the first time or a number called for the first time not otherwise in the contact directory. That is, after it has been determined that the call was initiated as discussed above, the processor may determine whether the call is via a telephone number that has not previously been used by the mobile telephone. For example, the processor may determine whether the telephone number is not currently associated with a contact that is stored in the memory of the mobile telephone. Alternatively, the processor may determine whether the telephone number has not previously been entered into the mobile telephone. For example, the processor may determine whether the telephone number is stored in any portion of memory within the mobile telephone.

If the processor has determined that the number entered by the user is not a new number, the details of the logged call are sent from the mobile telephone to the external database 211 at step S311. It will be understood that the logged call details may be sent to the database after each individual call, or in batches after a predetermined number of calls, at a predetermined time or after a predetermined duration.

The step of forwarding the logged call details to the database 211 includes initiating a connection with the database between the database and the mobile telephone via the portal 201. It will be understood that this connection may be a secure encrypted connection or any other suitable connection via the internet using a 3G or 4G data connection, for example. The logged call details are transmitted wirelessly to the database. These logged call details also include the user's account details to enable the database to store the logged calls against the user's account, which may also form part of a corporate account.

If the processor 205 determines that the number dialed by the user is a new number at step S309, a default electronic tag is applied to (i.e. associated with) that new number at step S313. A default electronic tag setting can be set by the user by accessing the portal. Alternatively, the user may set a default electronic tag setting in the configuration file of the software application within the mobile telephone.

The processor 205 in the portal 201 may also determine if the number dialed is a new number by comparing logs available from the database 211 with the communication data received from the telephone.

According to this embodiment, the user may set a default electronic tag value of “work” or “personal” as a tax-related category. This default setting is then automatically applied to any new number detected by the processor of the mobile telephone. That is, upon positively determining that the call being made by the mobile telephone has not previously been used, the processor automatically applies an electronic tag to that telephone number. This electronic tag associates the telephone number with a pre-stored tax-related category that was previously selected from a list of available pre-stored tax-related categories stored by the App. That is, in this case, the tax-related categories are “work” and “personal”.

It will be understood that, as an alternative, more than two tax-related categories may be set up in the settings and configuration of the App and/or via the portal. For example, where a user operates more than one business, multiple work categories may be provided.

It will be understood that, as an alternative, the electronic tag may be applied to a contact name instead of a specific telephone number. In this way, multiple telephone numbers associated with an individual contact are automatically associated using a single electronic tag. Regardless of whether the electronic tag is applied to a contact and/or a telephone number, the result is that call related data in the form of tagged data is created. This call related data or tagged data forms part of the call data stored by the App. It will be understood that further references herein related to tagged telephone numbers may also apply to tagged contacts as well as a combination of the two.

The pre-stored tax-related category may be a user-defined tax-related category that was previously selected by the user of the mobile telephone. Alternatively, the pre-stored tax-related category may be a default defined tax-related category that is stored within the mobile telephone or the database 211.

After applying the default tag at step S313, the telephone number along with the electronic tag is transmitted to the database 211 via the portal 201. Again, it will be understood that the logged call details may be sent to the database after each individual call, or in batches after a predetermined number of calls, at a predetermined time or after a predetermined duration, and so the tagging may occur at the portal 201 in conjunction with the database 211.

At step S315, the user is notified that a new number has been called. For example, the user interface may display a notification on the mobile telephone. Upon the processor detecting that the user has clicked on the notification, one or more new telephone numbers are displayed on the user interface of the mobile telephone along with the associated tax-related category that is associated with the electronic tag applied to that telephone number. This mobile telephone user interface enables the user to review and manually modify the tax-related category associated with the numbers. The user may also change the allocation for a particular number from one tax-related category to another tax-related category. If the processor in the telephone (or the portal) detects that the user has modified the tax-related category for a particular telephone number, a replacement electronic tag is then applied to that telephone number to update the tax-related category. That is, a new electronic tag associated with a different tax-related category selected from a list of pre-stored tax-related categories is applied to the telephone number.

At step S317, the user is able to review all the new calls that have been entered on the mobile telephone and update the electronic tag at step S319. According to one example, the user may review the new calls by logging in to the portal, using their account details in order to access all the call data that has been uploaded to the database. A user interface may be displayed on any suitable computing device to enable the user to review and browse a list of calls that have been made to new numbers. Alternatively, the user may view a list of new calls on the actual mobile telephone itself via the user interface displayed by the App.

In summary, the system described herein includes a software application program executed on a mobile telephone and a web service portal. The interaction of these two components enable a user to proactively tag, track and report their work related mobile usage. During an initial setup stage, the application software operation on the mobile telephone interfaces with the contact list and call log of the mobile telephone. The user's contacts and call details are transmitted from the mobile telephone to a database. The call details may include logs from the previous three weeks of usage of the mobile telephone, for example.

A list of new telephone numbers that were called by the user is displayed along with the tax-related categories associated with the electronic tags. If the tag is not updated by the user, the process ends at step S321. Whereas, if the tag is updated by the user at step S319 the portal updates the assigned tag to that telephone number at step S323 and communicates this information to the database 211 at step S325.

It will be understood that the information transmitted from the mobile telephone to the database may include the actual telephone number and the actual electronic tag. Alternatively, an association between a telephone number and a tax-related category may be transmitted to the database. For example, each tax-related category may have a unique ID associated with it and that unique ID may be attached to the telephone number or data that identifies the telephone number. This information may also be stored internally within the memory of the mobile telephone as well as being transmitted to the database 211.

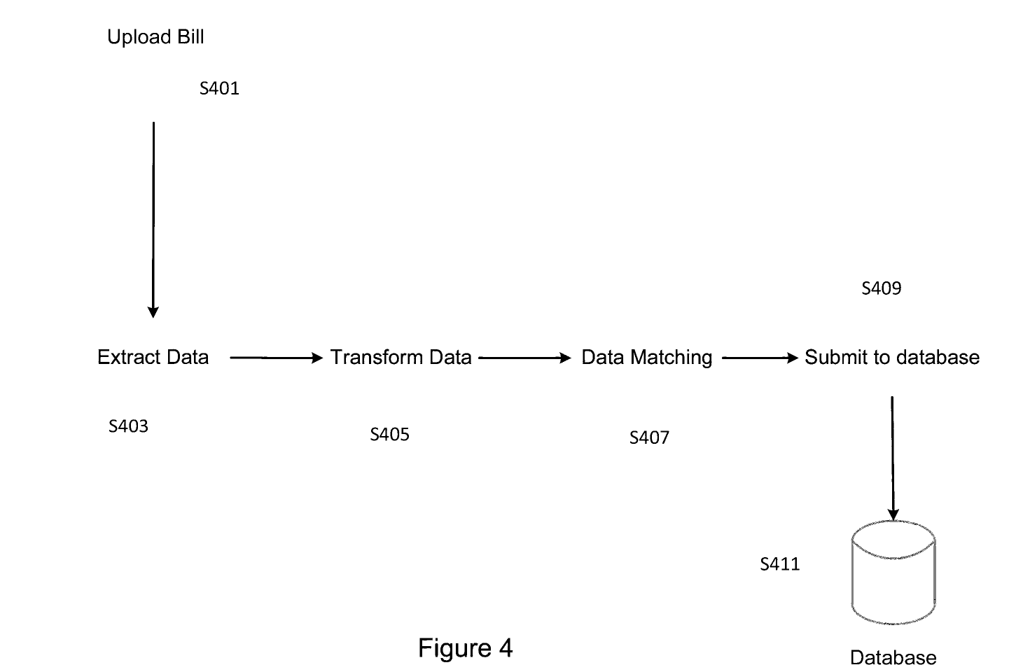

FIG. 4 describes a process whereby a user may upload a bill to the portal in order to extract the data and apply various algorithms prior to submitting the data to the database. At step S401, the user uploads the bill to the portal using any suitable computing device. The bill may be in an electronic format such as an electronic document (such as a PDF) or in an electronic file, such as in CSV (comma separated variable) format. It will be understood that other suitable formats may also be used. The file is sent to the portal using the user's account details to associate the bills with the user's account. The processor in the portal 201 extracts the data from the bill upon receiving the bill using a suitable algorithm.

In the case of a CSV file, data is extracted in a tab delimited state. This data is then submitted for storage in the database.

For a PDF file, data is extracted from that file using an algorithm that is selected depending on the telecommunication service provider. That is, depending upon the format of the bill, different algorithms are used to extract the data from the PDF file. The processor in the portal parses the data within the PDF file to detect a trigger point associated with a particular data item. For example, the processor may parse the PDF data to detect the word “mobile” and continue parsing to then subsequently detect another trigger point to find the date and costing information associated with different telephone numbers. It will be understood that different telecommunication providers have different formats for their bills and as such the algorithm may be modified to detect the various data items using different triggers in a different order.

Once the data has been extracted at step S403 in its raw form, either PDF data or structured CSV data, the next step is to transform the data at step S405. The data transformation process breaks down the data into its constituent parts. These separate data points are then stored separately in the database. For example, the date, time, type of call, location, number, duration and actual amount associated with each call may be stored in separate columns within the database.

Following the data transformation process at step S405, the data is then matched at step S407. This process involves comparing the data that has been extracted from the bill with the data previously collected by the software application program operating on the mobile telephone and subsequently transferred to the database, that is, all call logged data that has been transmitted to the database 211 at step S311 as shown in FIG. 3. This data includes both existing number data as well as new number data.

According to this embodiment, via a web page connected to the portal using a computing device, the user may create report cycles by entering a defined date range or period for a particular report cycle. For example, a report cycle may be monthly between two particular dates, such as, for example, from the 15^{th} of a first month to the 14^{th} of a second month and monthly thereafter. The report cycle data is transmitted and stored against the user's account via the portal so that when reports are created, any calls within those report cycles are analysed.

As an alternative, the user may create report cycles by entering a defined date range or period for a particular report cycle within the application software settings on the mobile telephone.

Further, the mobile telephone and the application software thereon may use these report cycles to display a summary of the call data on the mobile telephone within those report cycle periods. The purpose of enabling a user to enter report cycle date ranges is such that the data that is collected from calls being made on the mobile telephone as well as data that is collected from updated bills associated with the telecommunication provider are aligned to the correct period in order to mimic the contents of the user's monthly bill.

As shown in FIG. 6, during the initial setup stage, the report cycle is created at step S601 via a computing device connected to the portal. The user sets a date range for a billing cycle or report cycle at step S603. The user also enters costs associated with a mobile telecommunication plan from a telecommunication provider at step S605. The plan data may include data associated with the amount of calls that are available according to the plan that the user is using. In addition, additional bill components may be entered into the system at step S607. This data is then stored in the database at step S609.

It will also be understood that, as an alternative, the user may enter all the information referenced above with respect to FIG. 6 via a user interface on the mobile telephone generated by the App. Once all this data has been entered, it may then be transmitted from the mobile telephone to the database.

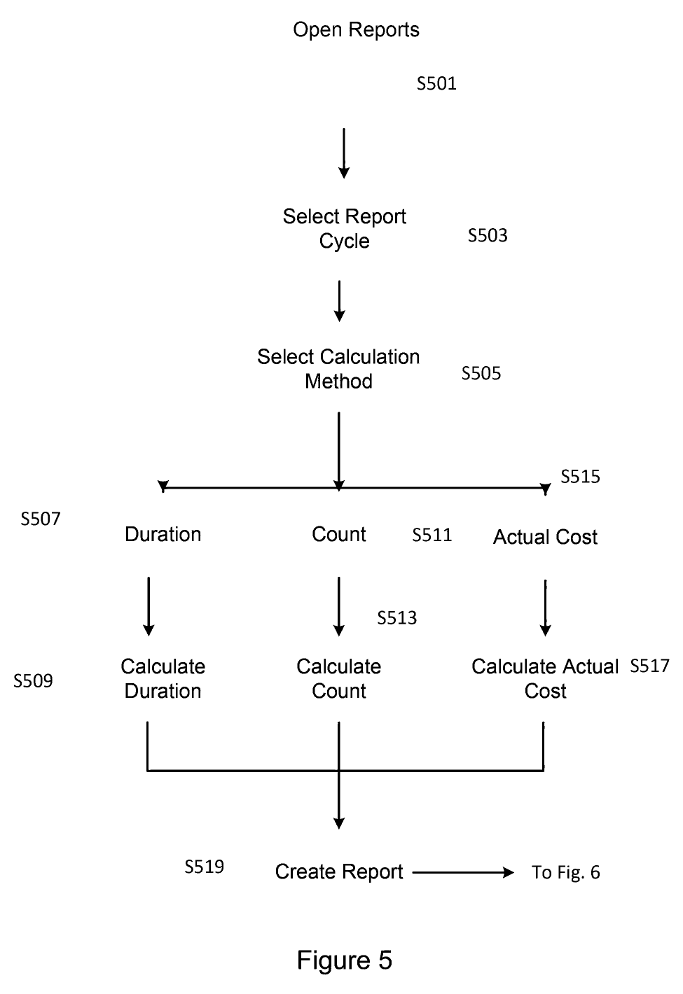

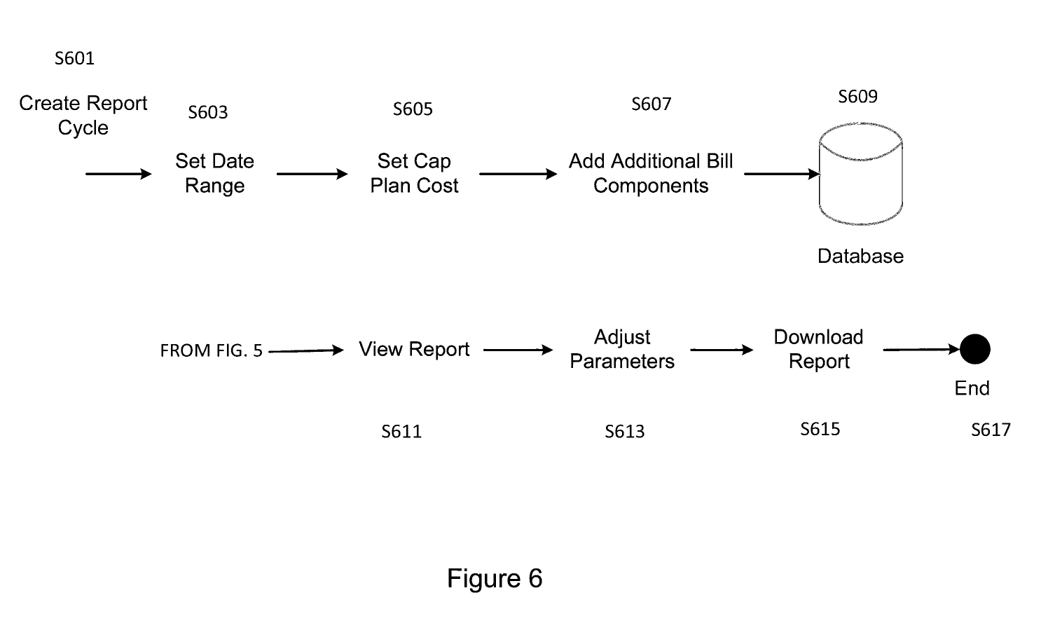

FIG. 5 shows details of the process for creating various reports associated with telephone calls made using the mobile telephone. Using the user's computing device, the user may select an option via the portal to open the report section of the website at step S501. The user selects a report cycle in the user interface at step S503. The user then selects a desired calculation method at step S505. According to various examples, three different types of calculation methods are provided. However, it will be understood that other or additional different calculation methods may also be used.

According to a first example, the user may select a duration calculation method at step S507. According to this example, the call log data transmitted to the database includes call duration data associated with the duration of each call made to telephone numbers using the mobile telephone. The reporting module determines using this call data a first total duration value that is calculated based on all the calls that were made by the mobile telephone in the defined billing period. The reporting module then determines using the call data a second total duration value which is calculated based on all of the calls that were made to specific telephone numbers by the mobile telephone. That is, the specific telephone numbers are the numbers that are associated with an electronic tag for a tax-related category identified as “work”. The system then calculates a tax claimable value using the first and second total duration values as well as the plan data previously entered by the user. According to this method, the system only relies on call related data that is collected by the software application program on the mobile telephone. There is no requirement for the system to use any billing data provided by the telecommunication provider. The system determines a percentage value based on the total duration of work calls and the total duration of all calls. This percentage may then be applied to the plan cost as well as other components associated with the user's telecommunications bill as entered by the user in order to generate a total claim cost.

For example, the total duration of all calls may be 160 minutes in a billing period. The total duration of all “work” tagged calls may be 40 minutes in that same billing period. Therefore, a percentage value of 25% is calculated for the tagged work calls. This percentage value is then applied to the call cost associated with the plan. Further, this 25% value may be applied to any data usage costs and plan repayment costs. These values are subsequently provided in the final report.

According to a second example, a count calculation method is selected at step S511 and the count calculation value is calculated at step S513. According to this example, the calculation of the tax claimable value is determined by the system using the call data in order to calculate a first total count value based upon the number of all the calls made in the defined billing period. Further, the system determines using the call data a second total count value which is based on all the calls that were made to telephone numbers that have an electronic tag for the “work” tax-related category. A tax claimable value is then calculated by the system based upon the first and second total count values and the plan data previously provided by the user. According to this method, the system only relies on data that is collected by the software application program on the mobile telephone. There is no requirement for the system to use billing data provided by the telecommunication provider. The system calculates a percentage value based on the total count of work calls which is expressed as a percentage of the total count of all calls. This percentage is then applied to the plan cost and other components of the user's bill in order to generate a total claim cost.

For example, the total number of calls made in a billing period may be 40. The total number of all “work” tagged calls may be 8 in that same billing period. Therefore, a percentage value of 20% is calculated for the tagged work calls. This percentage value is then applied to the call cost associated with the plan. Further, this 20% value may be applied to any data usage costs and plan repayment costs. These values are subsequently provided in the final report.

According to the third example, at step S515 the user selects the actual cost calculation method. The system then calculates the actual cost at step S517. According to this example, the system uses billing data that has been extracted from the electronic versions of the telecommunication provider's invoices or bills which are associated with the defined billing period as set by the user. After the billing data on the bills has been extracted, transformed and matched, the matched data is used to calculate the actual cost data associated with telephone numbers that have an electronic tag associated with a “work” tax-related category. That is, a tax claimable value is calculated for the defined billing period based on the actual cost of data obtained from the matched data. This is expressed as a percentage of the plan costs previously entered by the user as well as other cost components entered by the user.

Regardless of which calculation method has been selected by the user, after the calculation process has been performed, a report is created at step S519.

The following provides an example of how the system may match data that has been extracted, transformed and submitted to the database with data that has been collected by the software application program operating on the mobile telephone and subsequently communicated to the database. The processor in the portal may use various algorithms in order to compare the two sets of data and match the original call data with the actual costs from the bill. The processor breaks up the different components of the telephone number and uses the date, time and duration in order to compare the original call logged by the software application program and the data extracted from the bill. For example, this process may be required when the bill includes certain prefixes that are not necessarily stored or used by the software application program executed on the mobile telephone. When the processor determines a match, the data is combined and an actual cost of the call is stored in the database.

The web service may systematically attempt to match each row of call data that has been extracted from the bill against the data that is stored, i.e., received from the application software on the mobile telephone. Data matching may be performed on the following data points: number; date; time; duration. When the system determines that the data points match the system updates the original row of data created in the database by the application software with the actual cost of the call. The system continues this process for each row of data extracted from the bill. If a match cannot be found for the data that has been extracted from the bill with data that is stored in the database, a new data row may be created and this unmatched call is flagged to the user.

As an example, in order to match the telephone number, the system may count back a predefined number of digits from the end of the extracted telephone number from the bill and then perform data matching based on those digits. This effectively excludes any prefixes, e.g., area codes, which would not be captured by the application software on the mobile telephone.

Referring to FIG. 6, a user is able to request a report for viewing at step S611. This request may be made using a computing device connected to the portal. The report is then subsequently displayed on the user interface of the computing device and enables the user to manually adjust parameters at step S613. For example, the user may adjust the work related percentage assigned to various components within the report as calculated by the count or duration methods discussed above. These components may include SMS costs, data costs as well as other defined costs. By manually adjusting the percentages in each of the categories, the total claimable amount for each report cycle may be adjusted.

Once the report is completed, the user may download the report at step S615 to their computing device from the portal. The report may be downloaded in PDF or CSV format. The report includes aggregate data that can be used for submission within a tax return or an employee expense claim. The portal may also include supporting evidence within the downloaded report. This supporting evidence may include details of the calls and the call logs. The process then ends at step S617.

Additional bill components may be included in the report, such as the cost of paying for the actual mobile telephone as part of the user's plan, e.g. the repayment value. Further, other bill components may be made for further costs associated with the user such as extra data costs (such as those associated with emails, accessing the internet, application usage and downloading of content) and SMS costs. The percentage value calculated using any of the three herein described calculation methods (duration, count, actual costs) may then be applied to the other value by the system. The following paragraph provides an example of how the system may calculate certain values for a user.

Although communication related data in the form of call data may be used to create financial reports, it will also be understood that and SMS communications are also related to particular numbers and/or contacts associated with the mobile telephone. Therefore, these communications may also be tracked and tagged in a similar way as described for the call data. Further, communications in the form of emails may also be associated with a particular contact and/or email address and so associated with a particular contact number. Therefore, data usage incurred when sending emails may also be tagged in a similar manner.

Therefore, the system may determine whether a communication had been initiated on the mobile telephone. Upon the mobile telephone making a positive determination that the communication had been initiated, it then determines whether the communication uses communication related data that has not been previously used by the mobile communication device. Upon, the mobile telephone making a positive determination, the mobile telephone automatically applies an electronic tag to the communication related data.

It will be understood that costs associated with data may be estimated where a contact is recorded having, for example, an email address, position and telephone number as identifiers. The system may use these identifiers to estimate file size and data usage from the email address. This information may then be cross-referenced with the telephone number or any other identifying trait to estimate costs by applying this information to a scanned telephone bill.

As a further example, a user has an $80 cap plan, with 2 GB of included data and unlimited SMS. The user also pays an extra $35 each month for an additional 4 GB of data as he regularly calls clients via Skype™. The user also regularly checks work email and sends numerous emails on the go during the day as he travels from one client site to another. The user makes the odd work related phone call, outside Skype™. Based on the user's usage the portal report inform the user that only 27% of their standard telephone calls are work related, based on the way the contact telephone numbers are tagged. The user knows that a far higher percentage of data allowance is used for work purposes. By accessing the portal, the user can increase the work related percentage assigned to the additional data pack purchased, thereby increasing the value of the amount allocated for a tax return. The fact this this percentage has been changed will be itemised in the final report that is generated and is maintained as evidence for the tax return.

In summary, the system as a whole includes a computing system with a processor in the form of a portal that has a communication interface which communicates with the mobile telephone via a communication network. Further, a database is used for storing plan data associated with the mobile telephone. The communication interface enables plan data to be retrieved from the database. This plan data is associated with the telephone calls that are made on the mobile telephone. Further, call data is also retrieved via the communication interface from the database. This call data is associated with one or more calls that have been made using the mobile telephone within a defined billing period. The call data also includes details of the telephone numbers that were called within that billing period. Further, electronic tags associated with those telephone numbers are also provided within the call data. The electronic tags enable the telephone numbers to be associated with a tax related category such as “work”. The tax related category is selected from a list of predefined tax related categories provided to the user in the application software on the mobile telephone. The processor within the computing system is then able to calculate a tax claimable value for the defined billing period based on the plan data retrieved from the database and the call data also retrieved from the database. A report is then created and provided to the user identifying the tax claimable value and associated details.

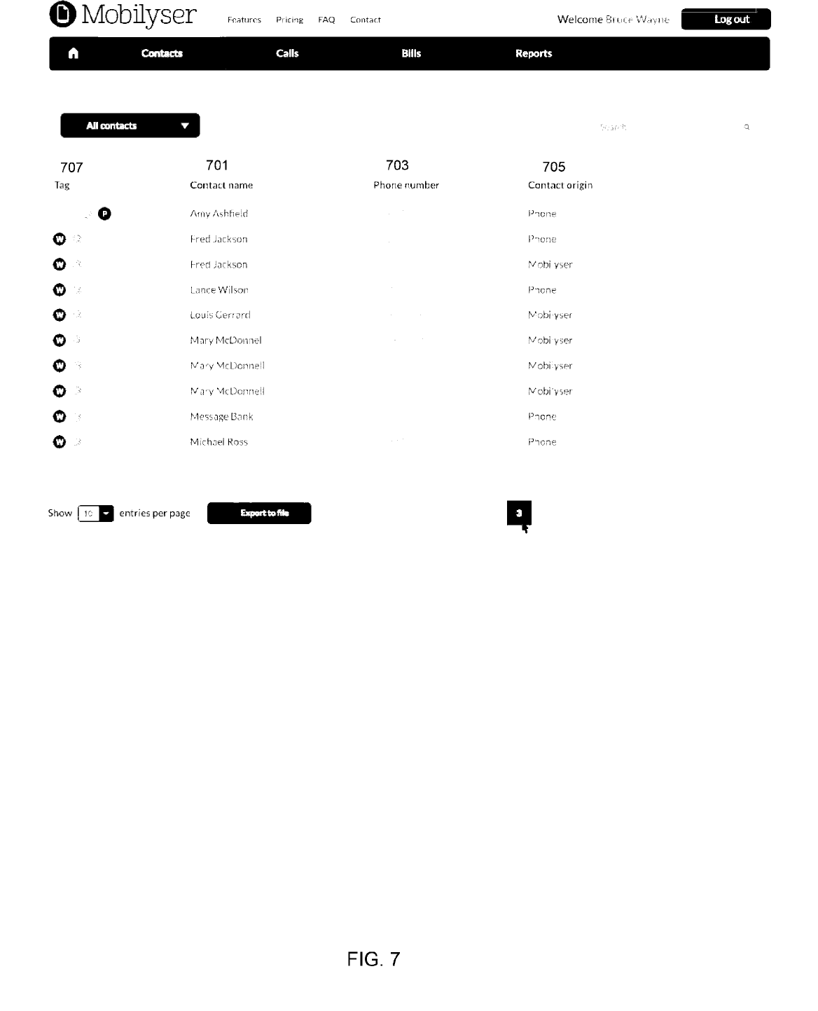

FIG. 7 shows a screen shot of a user interface as accessed via the portal to enable the user to review contact details and telephone numbers stored by the web server. According to this example, contact names 701 are listed. Phone numbers 703 associated with each of those contact names are provided. An indication of the origin 705 of those contact details is provided for each of the listed numbers. For example, the origin of the contact may be from the mobile telephone itself, or may have been entered by the user using the portal and the user's computing device. Electronic tag details 707 are provided for each of the listed contact names and telephone numbers. The indication “W” indicates that the telephone number is associated with a work tax-related category, whereas the “P” indicates that the telephone number is associated with a private tax-related category.

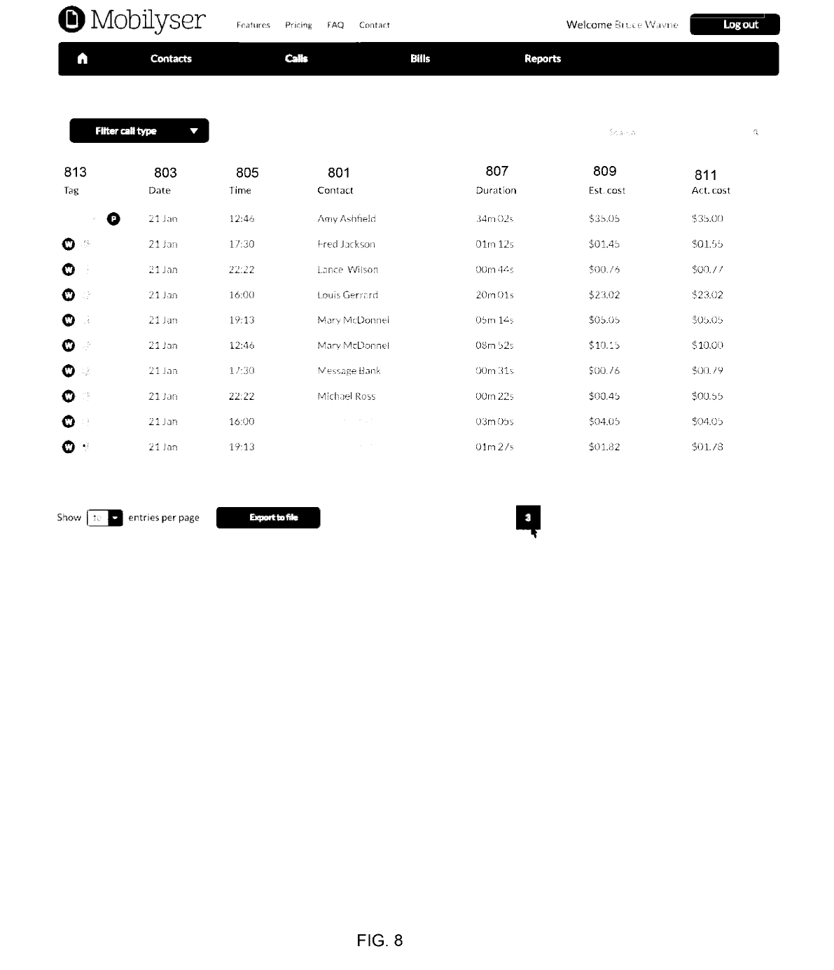

FIG. 8 shows call and cost details for the various contacts and telephone numbers associated with the user's account. Contact details 801 are listed along with the date 803 and time 805 of the calls made to that contact. The duration of each of the calls is identified in column 807 along with the estimated cost 809 and the actual cost 811 where available. The electronic tag details are also provided in column 813 in a similar manner as discussed directly above.

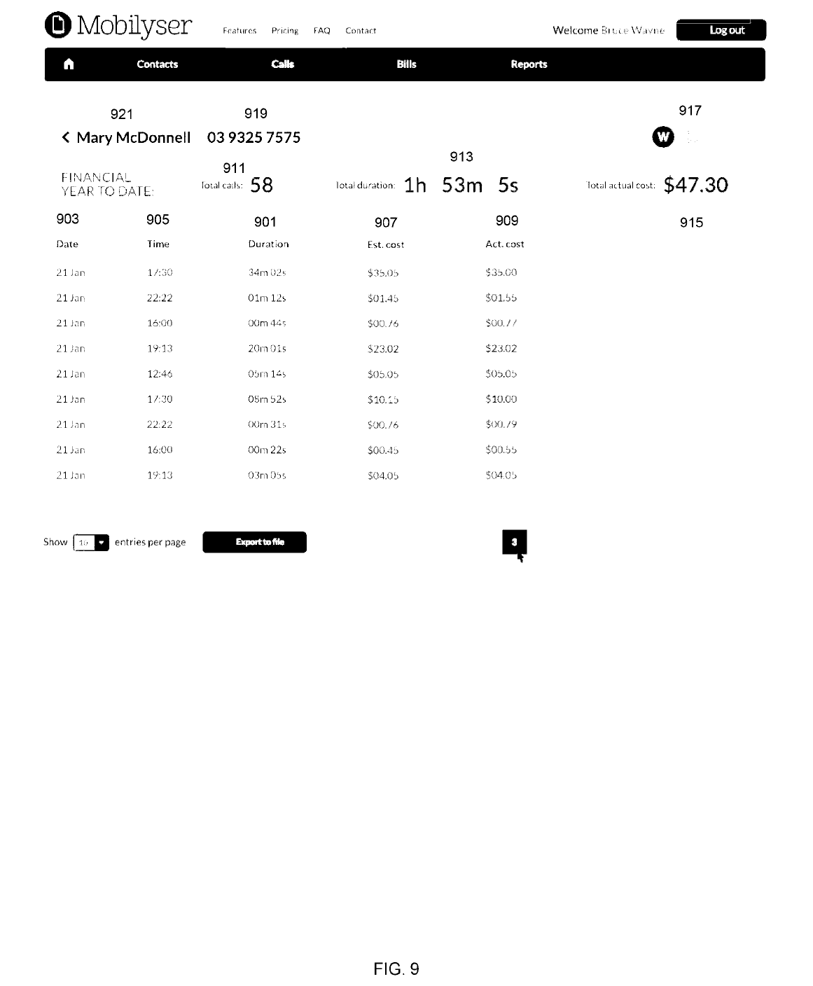

FIG. 9 shows a further screen shot of the user interface available via the portal. According to this screen shot, details of a single contact 921 and telephone number 919 are provided for the financial year to date. Details of various calls made including the duration 901, date 903 and time of the call 905 are listed. Estimated costs are provided in column 907 and the actual cost is provided in column 909. The total number of calls 911 is also displayed 911 along with the total duration 913 of calls. The total actual cost value 915 is also displayed. The electronic tag 917 associated with that particular caller and telephone number is displayed.

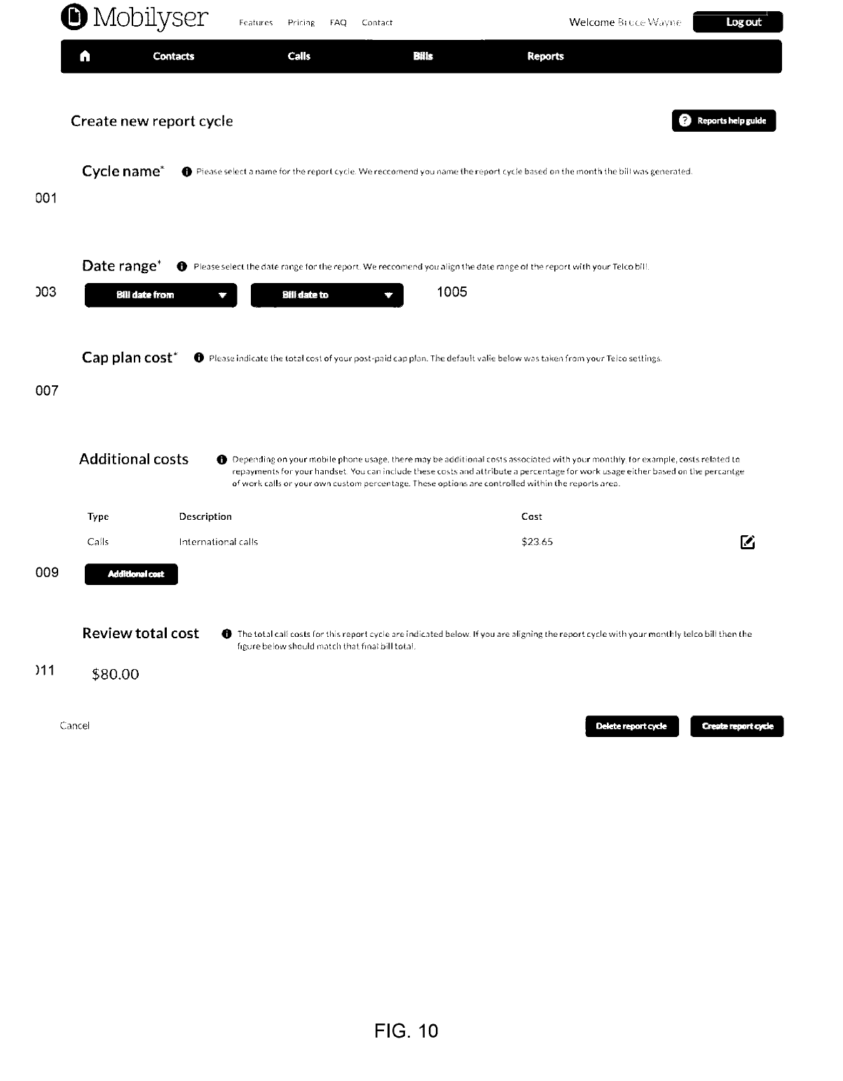

FIG. 10 shows a user interface screenshot available to a user in order for them to create a new report cycle via the portal. The user may enter the cycle name, i.e., a name for the report cycle, in the window 1001. A date range may be selected from the dropdown menus labelled “Bill date from” 1003 and “Bill date to” 1005. The user can enter the plan costs associated with the mobile telephone in window 1007.

Further, additional costs may also be added by selecting the additional cost button 1009. That is, additional costs may be associated with text messaging (SMS), data allowance and repayments for the purchase of the handset. A total cost is calculated by the system and shown as a review of the total cost 1011. When the user selects the additional cost button, the user selects the type of the additional cost, which may be, for example, international calls. The actual value associated with the additional cost is also entered.

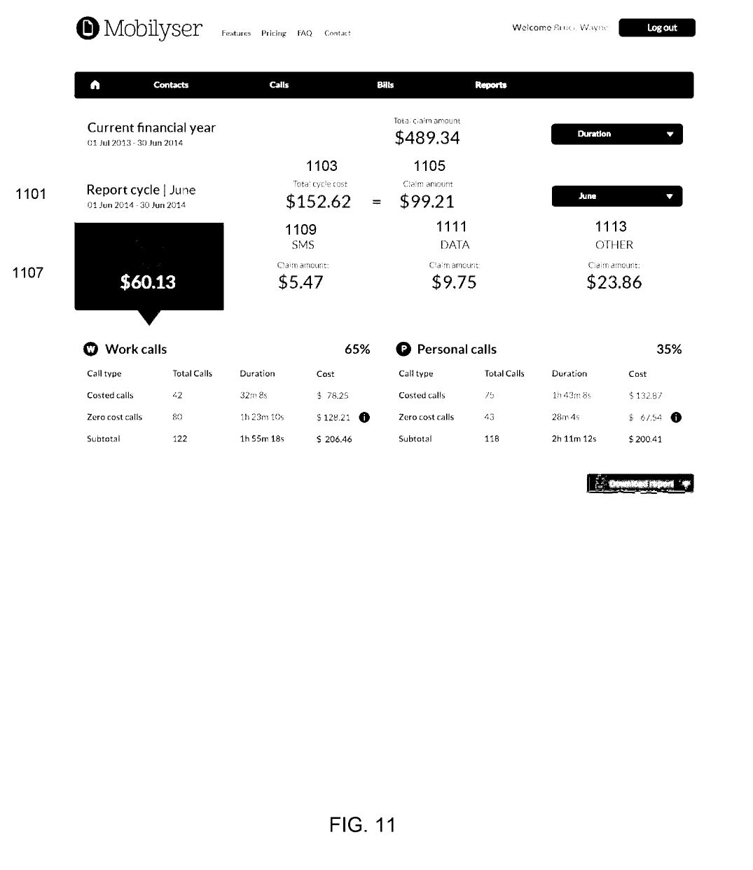

FIG. 11 shows an example report generated by the web service. The report includes the report cycle details 1101, the total cycle costs 1103, as well as the claimable amount 1105. The costs are broken down into calls 1107, SMS 1109, data 1111 and other 1113. Details for each of these four categories may then be displayed by selecting the appropriate tab. For example by selecting the calls tab 1107, a list of the electronic tagged work calls and the electronic tagged personal calls are displayed. According to this example, work calls make up 65% of the total calls that have been made, whereas personal calls make up 35% of the total calls that have been made by the mobile telephone.

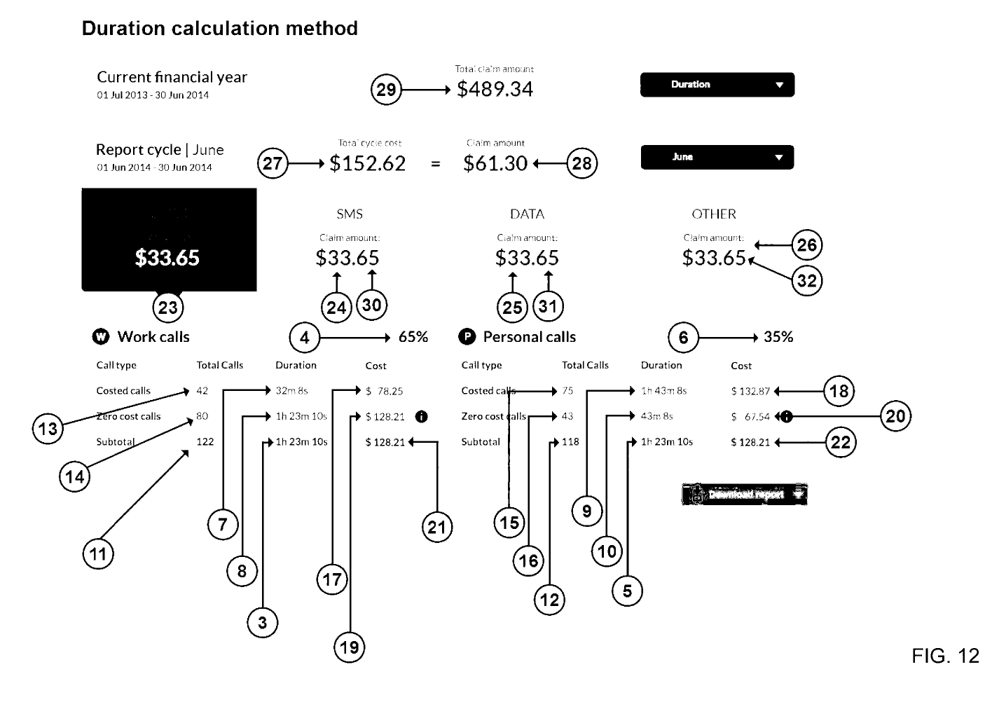

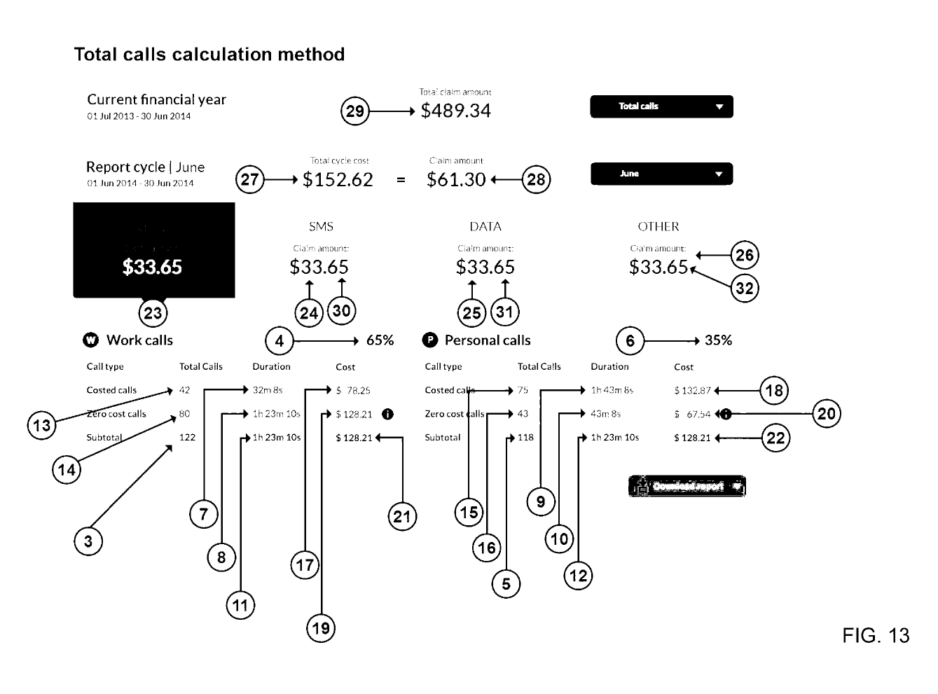

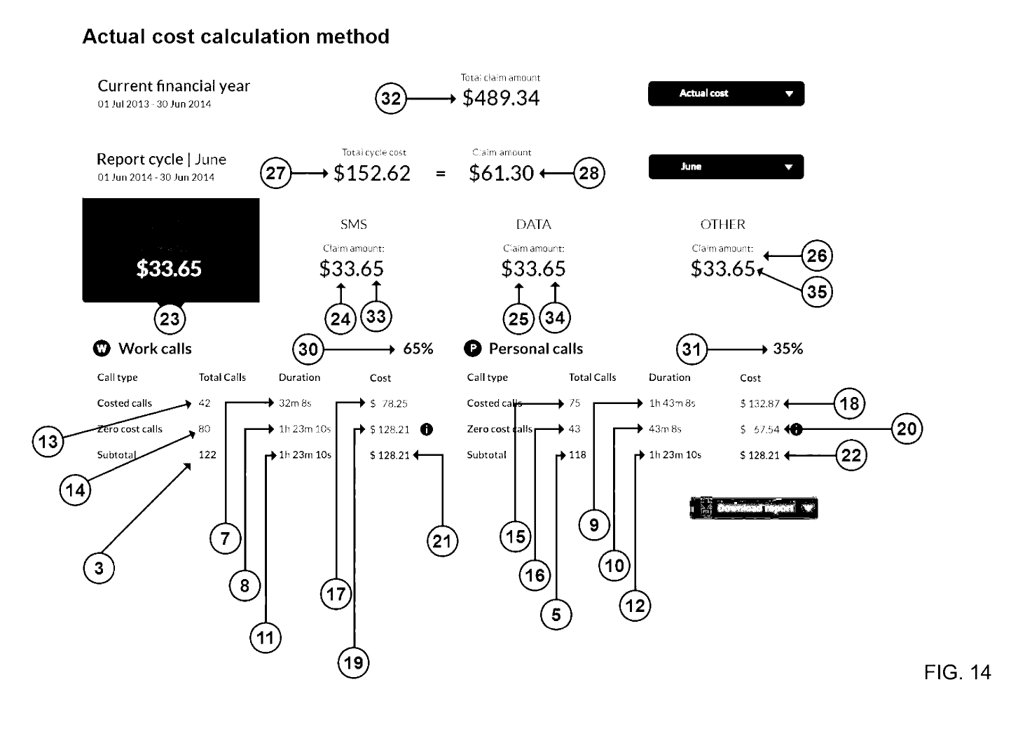

The following tables provide further details of how various values are calculated using the duration calculation method (see Table 1 and FIG. 12), total calls calculation method (see Table 2 and FIG. 13) and actual cost calculation method (see Table 3 and FIG. 14).

TABLE 1
Algorithm for duration calculation method

| ID | Title | Description | Notes |
|---|---|---|---|
| 1 | Gather calls | FIND all calls within the date | Date range is specified as 00:00:00 on |
| | | range of the currently selected | a specific date to 23:59:59 on a specific |
| | | report cycle | date. |
| 2 | Total duration | CALCULATE total duration of | The total duration is expressed as |
| | | calls within the specified date | 100% of calls for the current selected |
| | | range of the currently selected | report cycle |
| | | report cycle | |
| 3. | Calculate total | CALCULATE the total | |
| | duration of calls | duration of calls tagged as | |
| | with ‘work’ tag | work related | |
| 4. | Total duration | CALCULATE the total | |
| | of work calls > | duration of work calls as a | |
| | Percentage | percentage of the total | |
| | | duration (100%) of all calls | |
| | | with the date range of the | |
| | | current selected report cycle | |
| 5. | Calculate the | CALCULATE the total | |
| | total duration of | duration of calls tagged as | |
| | calls with | personal related | |
| | ‘personal’ tag | | |
| 6. | Total duration | CALCULATE the total | |
| | of personal | duration of personal calls as a | |
| | calls > | percentage of the total | |
| | Percentage | duration (100%) of all calls | |
| | | with the date range of the | |
| | | current selected report cycle | |
| 7. | Duration of | CALCULATE the total | |
| | work calls with | duration of work calls with an | |
| | actual costs | actual cost of more than $0.00 | |
| 8. | Duration of | CALCULATE the total | |
| | work calls with | duration of work calls with an | |
| | zero actual cost | actual of of $0.00 | |
| 9. | Duration of | CALCULATE the total | |
| | personal calls | duration of personal calls with | |
| | with actual | an actual cost of greater than | |
| | costs | $0.00 | |
| 10. | Duration of | CALCULATE the total | |
| | personal calls | duration of personal calls with | |
| | with zero actual | an actual of of $0.00 | |
| | cost | | |
| 11. | Count of all | COUNT the number of calls | |
| | work tagged | within the specified date range | |
| | calls | of the currently selected report | |
| | | cycle tagged as work | |
| 12 | Count of all | COUNT the number of calls | |
| | personal | within the specified date range | |
| | tagged calls | of the currently selected report | |
| | | cycle tagged as personal | |
| 13. | Count of costed | COUNT the number of calls | |
| | calls with work | within the specified date range | |
| | tag | of the currently selected report | |
| | | cycle | |
| | | AND tagged as work | |
| | | AND have an actual cost of | |
| | | greater than $0.00 | |
| 14 | Count of zero | COUNT the number of calls | |
| | cost calls with | within the specified date range | |
| | work tag | of the currently selected report | |
| | | cycle | |
| | | AND tagged as work | |
| | | AND have an actual cost of | |
| | | $0.00 | |
| 15. | Count of costed | COUNT the number of calls | |
| | calls with | within the specified date range | |
| | personal tag | of the currently selected report | |
| | | cycle | |
| | | AND tagged as personal | |
| | | AND have an actual cost of | |
| | | greater than $0.00 | |
| 16. | Count of zero | COUNT the number of calls | |
| | cost calls with | within the specified date range | |
| | personal tag | of the currently selected report | |
| | | cycle | |
| | | AND tagged as personal | |
| | | AND have an actual cost of | |
| | | $0.00 | |
| 17. | Total actual | CALCULATE the total actual | |
| | cost of costed | cost of all calls tagged as | |
| | work calls | work | |
| | | WHERE actual cost field is | |
| | | greater than $0.00 | |
| 18. | Total actual | CALCULATE the total actual | |
| | cost of costed | cost of all calls tagged as | |
| | personal calls | personal | |
| | | WHERE actual cost field is | |
| | | greater than $0.00 | |
| 19. | Calculate actual | CALCULATE total cost of | Scenario |
| | cost of zero | zero cost work calls for the | Harry has a cap plan of $80. The report |
| | cost work calls | current report cycle by | cycle Harry is currently reporting on |
| | | CONVERTING 7. (Duration of | shows that Harry spent a total $95 on |
| | | work calls with actual costs | calls in the report cycle. |
| | | = nc) into seconds | The total duration in seconds of work |
| | | e.g. 04h15m39s or 04:15:39 | calls for which Harry has an actual cost |
| | | becomes 15339 s (=ns) | included is 15339 seconds |
| | | THEN calculate per second | In order to work out a per second call |
| | | cost | cost for costed work calls, the system |
| | | 17. (Total actual cost of costed | now divides the actual cost of costed |
| | | work calls = y)/7. (Duration | work calls (which for Harry is $340) by |
| | | of work calls with actual costs | the duration of work calls with actual |
| | | (expressed in second) = ns) = | costs. |
| | | per second call charge (ps) | For this scenario the per second call |
| | | THEN convert 8. (Duration of | cost is calculated at |
| | | work calls with zero costs = | $0.0221657213638438 |
| | | nz) into seconds | This per second call charge is then |
| | | e.g. 09h25m12s or 09:25:12 | used to calculate the actual cost of zero |
| | | becomes 33912 s | cost calls. |
| | | THEN calculate total actual | If the system multiplies the per second |
| | | cost of zero cost work calls | call charge of $0.0221657213638438 |
| | | ps (per second call charge) × | by the duration of work calls with zero |
| | | nz (duration of work calls with | costs, which is 33912 seconds then the |
| | | zero costs) | system arrives at the actual cost for |
| | | | zero cost calls. |
| | | | Therefore, the cost for Harry's zero cost |
| | | | work calls is $751.68 (rounded to two |
| | | | decimal places) |
| 20. | Calculate actual | CALCULATE total cost of | Scenario |
| | cost of zero | zero cost personal calls for | Harry has a cap plan of $80. The report |
| | cost personal | the current report cycle by: | cycle Harry is currently reporting on |
| | calls | CONVERTING 9. (duration of | shows that Harry spent a total $95 on |
| | | personal calls with actual cost = | calls in the report cycle. |
| | | nc) into seconds | The total duration in seconds of |
| | | e.g 10h6m22s or 10:06:22 | personal calls for which Harry has an |
| | | becomes 36382 s (= ns) | actual cost included is 36382 seconds |
| | | THEN calculate per second | In order to work out a per second call |
| | | cost | cost for costed personal calls, the |
| | | 18. (Total actual cost of costed | system now divides the actual cost of |
| | | personal calls = y)/7. | costed personal calls (which for Harry is |
| | | (Duration of personal calls | $220) by the duration of work calls with |
| | | with actual costs (expressed in | actual costs. |
| | | second) = ns) = | For this scenario the per second call |
| | | per second call charge (ps) | cost is calculated at |
| | | THEN convert 10. (Duration of | $0.0604727872457394 |
| | | personal calls with zero costs = | This per second call charge is then |
| | | nz) into seconds | used to calculate the actual cost of zero |
| | | e.g 4h16m5s or 04:16:05 | cost calls. |
| | | becomes 15365 s | If the system multiplies the per second |
| | | THEN calculate total actual | call charge of $0.0604727872457394 |
| | | cost of zero cost personal | by the duration of work calls with zero |
| | | calls | costs, which is 15365 seconds then the |
| | | ps (per second call charge) × | system arrives at the actual cost for |
| | | nz (duration of personal calls | zero cost calls. |
| | | with zero costs) | Therefore, the cost for Harry's zero cost |
| | | | work calls is $929.16 (rounded to two |
| | | | decimal places) |
| 21. | Total actual | TOTAL the results of the | |
| | cost for work | following calculations | |
| | calls | 17. (Total actual cost of costed | |
| | | work calls) + 19. (Calculate | |
| | | actual cost of zero cost work | |
| | | calls) = Total actual cost for | |
| | | work calls | |
| 22. | Total actual | TOTAL the results of the | |
| | cost for | following calculations | |
| | personal calls | 18. (Total actual cost of costed | |
| | | personal calls) + 20. | |
| | | (Calculate actual cost of zero | |
| | | cost personal calls) = Total | |
| | | actual cost for personal calls | |
| 23 | Calls-claim | CALCULATE the total claim | |
| | amount | amount for calls by | |
| | | DEDUCTING total additional | |
| | | costs for SMS, Data and Other | |
| | | from total cost for current | |
| | | report cycle = C | |
| | | THEN applying 4. (Total | |
| | | duration of work calls > | |
| | | Percentage) to C (total | |
| | | amount for calls) = Total calls | |
| | | claim amount | |
| 24. | SMS-claim | CALCULATE the total claim | |
| | amount (on | amount for SMS by | |
| | initial load calc) | SUM of all additional costs | |
| | | assigned to SMS category for | |
| | | the current report cycle = S | |
| | | THEN applying 4. (Total | |
| | | duration of work calls > | |
| | | Percentage) to S (total amount | |
| | | for SMS) = Total SMS claim | |
| | | amount | |
| 25. | Data-claim | CALCULATE the total claim | |
| | amount (on | amount for data by | |
| | initial load calc) | SUM of all additional costs | |
| | | assigned to SMS category for | |
| | | the current report cycle = D | |
| | | THEN applying 4. (Total | |
| | | duration of work calls > | |
| | | Percentage) to D (total | |
| | | amount for data) = Total Data | |
| | | claim amount | |
| 26. | Other-claim | CALCULATE the total claim | |
| | amount (on | amount for data by | |
| | initial load calc) | SUM of all additional costs | |
| | | assigned to Other category for | |
| | | the current report cycle = O | |
| | | THEN applying 4. (Total | |
| | | duration of work calls > | |
| | | Percentage) to O (total | |
| | | amount for other) = Total | |
| | | Other claim amount | |
| 27. | Total cycle cost | TRANSFER total cycle cost | |
| | | from total cost of current | |
| | | report cycle | |
| 28. | Claim amount | SUM the result of the following | |
| | (current report | calculations: | |
| | cycle) | 23 + 24 + 25 + 26 = Claim | |
| | | amount current report cycle | |
| 29. | Total claim | REPEAT algorithm steps 1-24 | Financial year dates may be stored |
| | amount (current | with consideration that the | within the database in a suitable form. |
| | financial year) | ‘current report cycle’ is | This ensures that the current financial |
| | | between 01 July YYYY | year can be displayed on the reports |
| | | 00:00:00 to 30 June 23:59:59 | page and the correct date span is used |
| | | | to calculate the claim figure for the |
| | | | current financial year. |
| | | | Given that the reporting page will load |
| | | | and calculate claim amounts based on |
| | | | the user's default setting, the total claim |
| | | | amount may be cached for the current |
| | | | financial year. |
| | | | Alternatively, a wide date span |
| | | | calculation may be made on the fly. |
| | | | It will be understood that the system |
| | | | may only re-calculate this figure on the |
| | | | fly if the user changes the calculation |
| | | | method. |
| 30. | SMS-claim | CALCULATE the total claim | |
| | amount (on | amount for SMS by | |
| | change % calc) | SUM of all additional costs | |
| | | assigned to SMS category for | |
| | | the current report cycle = S | |
| | | THEN apply % set by the user | |
| | | to S (total amount for SMS) = | |
| | | Total SMS claim amount | |
| 31. | Data-claim | CALCULATE the total claim | |
| | amount (on | amount for Data by | |
| | change % calc) | SUM of all additional costs | |
| | | assigned to Other category for | |
| | | the current report cycle = D | |
| | | THEN apply % set by the user | |
| | | to D (total amount for Data) = | |
| | | Total Data claim amount | |
| 32. | Other-claim | CALCULATE the total claim | |
| | amount (on | amount for Other by | |
| | change % calc) | SUM of all additional costs | |
| | | assigned to Other category for | |
| | | the current report cycle = O | |
| | | THEN apply % set by the user | |
| | | to O (total amount for Other) = | |
| | | Total Other claim amount | |

TABLE 2
Algorithm for total calls calculation method

| ID | Title | Description | Notes |
|---|---|---|---|
| 1 | Gather calls | FIND all calls within the date | Date range is specified as 00:00:00 on a |
| | | range of the currently selected | specific date to 23:59:59 on a specific |
| | | report cycle | date. |
| 2 | Total count | CALCULATE total count of | The total count is expressed as 100% of |
| | | calls within the specified date | calls for the current selected report cycle |
| | | range of the currently selected | |
| | | report cycle | |
| 3. | Calculate total | CALCULATE the total count | |
| | count of calls | of calls tagged as work | |
| | with ‘work’ tag | related | |
| 4. | Total count of | CALCULATE the total count | |
| | work calls > | of work calls as a percentage | |
| | Percentage | of the total count (100%) of all | |
| | | calls with the date range of | |
| | | the current selected report | |
| | | cycle | |
| 5. | Calculate the | CALCULATE the total count | |
| | total count of | of calls tagged as personal | |
| | calls with | related | |
| | ‘personal’ tag | | |
| 6. | Total count of | CALCULATE the total count | |
| | personal calls > | of personal calls as a | |
| | Percentage | percentage of the total count | |
| | | (100%) of all calls with the | |
| | | date range of the current | |
| | | selected report cycle | |
| 7. | Duration of | CALCULATE the total | |
| | work calls with | duration of work calls with an | |
| | actual costs | actual cost of more than $0.00 | |
| 8. | Duration of | CALCULATE the total | |
| | work calls with | duration of work calls with an | |
| | zero actual cost | actual of of $0.00 | |
| 9. | Duration of | CALCULATE the total | |
| | personal calls | duration of personal calls with | |
| | with actual | an actual cost of greater than | |
| | costs | $0.00 | |
| 10. | Duration of | CALCULATE the total | |
| | personal calls | duration of personal calls with | |
| | with zero actual | an actual of of $0.00 | |
| | cost | | |
| 11. | Duration of all | CALCULATE the duration of | |
| | work tagged | calls within the specified date | |
| | calls | range of the currently selected | |
| | | report cycle tagged as work | |
| 12 | Duration of all | CALCULATE the duration of | |
| | personal | calls within the specified date | |
| | tagged calls | range of the currently selected | |
| | | report cycle tagged as | |
| | | personal | |
| 13. | Count of costed | COUNT the number of calls | |
| | calls with work | within the specified date range | |
| | tag | of the currently selected report | |
| | | cycle | |
| | | AND tagged as work | |
| | | AND have an actual cost of | |
| | | greater than $0.00 | |
| 14 | Count of zero | COUNT the number of calls | |
| | cost calls with | within the specified date range | |
| | work tag | of the currently selected report | |
| | | cycle | |
| | | AND tagged as work | |
| | | AND have an actual cost of | |
| | | $0.00 | |
| 15. | Count of costed | COUNT the number of calls | |
| | calls with | within the specified date range | |
| | personal tag | of the currently selected report | |
| | | cycle | |
| | | AND tagged as personal | |
| | | AND have an actual cost of | |
| | | greater than $0.00 | |
| 16. | Count of zero | COUNT the number of calls | |
| | cost calls with | within the specified date range | |
| | personal tag | of the currently selected report | |
| | | cycle | |
| | | AND tagged as personal | |
| | | AND have an actual cost of | |
| | | $0.00 | |
| 17. | Total actual | CALCULATE the total actual | |
| | cost of costed | cost of all calls tagged as | |
| | work calls | work | |
| | | WHERE actual cost field is | |
| | | greater than $0.00 | |
| 18. | Total actual | CALCULATE the total actual | |
| | cost of costed | cost of all calls tagged as | |
| | personal calls | personal | |
| | | WHERE actual cost field is | |
| | | greater than $0.00 | |
| 19. | Calculate | CALCULATE total cost of | Scenario |
| | actual cost of | zero cost work calls for the | Harry has a cap plan of $80. The report |
| | zero cost work | current report cycle by | cycle Harry is currently reporting on |
| | calls | CONVERTING 7. (Duration of | shows that Harry spent a total $95 on |
| | | work calls with actual costs = | calls in the report cycle. |
| | | nc) into seconds | The total duration in seconds of work |
| | | e.g 04h15m39s or 04:15:39 | calls for which Harry has an actual cost |
| | | becomes 15339 s (=ns) | included is 15339 seconds |
| | | THEN calculate per second | In order to work out a per second call |
| | | cost | cost for costed work calls, the system |
| | | 17. (Total actual cost of | divides the actual cost of costed work |
| | | costed work calls = y)/7. | calls (which for Harry is $340) by the |
| | | (Duration of work calls with | duration of work calls with actual costs. |
| | | actual costs (expressed in | For this scenario the per second call |
| | | second) = ns) = | cost is calculated at |
| | | per second call charge (ps) | $0.0221657213638438 |
| | | THEN convert 8. (Duration of | This per second call charge is then used |
| | | work calls with zero costs = | to calculate the actual cost of zero cost |
| | | nz) into seconds | calls. |
| | | e.g 09h25m12s or 09:25:12 | If the system multiplies the per second |
| | | becomes 33912 s | call charge of $0.0221657213638438 by |
| | | THEN calculate total actual | the duration of work calls with zero |
| | | cost of zero cost work calls | costs, which is 33912 seconds then the |
| | | ps (per second call charge) × | system arrives at the actual cost for zero |
| | | nz (duration of work calls with | cost calls. |
| | | zero costs) | Therefore, the cost for Harry's zero cost |
| | | | work calls is $751.68 (rounded to two |
| | | | decimal places) |
| 20. | Calculate | CALCULATE total cost of | Scenario |
| | actual cost of | zero cost personal calls for | Harry has a cap plan of $80. The report |
| | zero cost | the current report cycle by: | cycle Harry is currently reporting on |
| | personal calls | CONVERTING 9. (duration of | shows that Harry spent a total $95 on |
| | | personal calls with actual cost = | calls in the report cycle. |
| | | nc) into seconds | The total duration in seconds of |
| | | e.g 10h6m22s or 10:06:22 | personal calls for which Harry has an |
| | | becomes 36382 s (=ns) | actual cost included is 36382 seconds |
| | | THEN calculate per second | In order to work out a per second call |
| | | cost | cost for costed personal calls, the |
| | | 18. (Total actual cost of | system divides the actual cost of costed |
| | | costed personal calls = y)/7. | personal calls (which for Harry is $220) |
| | | (Duration of personal calls | by the duration of work calls with actual |
| | | with actual costs (expressed | costs. |
| | | in second) = ns) = | For this scenario the per second call |
| | | per second call charge (ps) | cost is calculated at |
| | | THEN convert 10. (Duration of | $0.0604727872457394 |
| | | personal calls with zero costs = | This per second call charge is then used |
| | | nz) into seconds | to calculate the actual cost of zero cost |
| | | e.g 4h16m5s or 04:16:05 | calls. |
| | | becomes 15365 s | If the system multiplies the per second |
| | | THEN calculate total actual | call charge of $0.0604727872457394 by |
| | | cost of zero cost personal | the duration of work calls with zero |
| | | calls | costs, which is 15365 seconds then the |
| | | ps (per second call charge) × | system arrives at the actual cost for zero |
| | | nz (duration of personal calls | cost calls. |
| | | with zero costs) | Therefore, the cost for Harry's zero cost |
| | | | work calls is $929.16 (rounded to two |
| | | | decimal places) |
| 21. | Total actual | TOTAL the results of the | |
| | cost for work | following calculations | |
| | calls | 17. (Total actual cost of | |
| | | costed work calls) + 19. | |
| | | (Calculate actual cost of zero | |
| | | cost work calls) = Total actual | |
| | | cost for work calls | |
| 22. | Total actual | TOTAL the results of the | |
| | cost for | following calculations | |
| | personal calls | 18. (Total actual cost of | |
| | | costed personal calls) + 20. | |
| | | (Calculate actual cost of zero | |
| | | cost personal calls) = Total | |
| | | actual cost for personal calls | |
| 23 | Calls-claim | CALCULATE the total claim | |
| | amount | amount for calls by | |
| | | DEDUCTING total additional | |
| | | costs for SMS, Data and | |
| | | Other from total cost for | |
| | | current report cycle = C | |
| | | THEN applying 4. (Total count | |
| | | of work calls > Percentage) to | |
| | | C (total amount for calls) = | |
| | | Total calls claim amount | |
| 24. | SMS-claim | CALCULATE the total claim | |
| | amount (on | amount for SMS by | |
| | initial load calc) | SUM of all additional costs | |
| | | assigned to SMS category for | |
| | | the current report cycle = S | |
| | | THEN applying 4. (Total count | |
| | | of work calls > Percentage) to | |
| | | S (total amount for SMS) = | |
| | | Total SMS claim amount | |
| 25. | Data-claim | CALCULATE the total claim | |
| | amount (on | amount for data by | |
| | initial load calc) | SUM of all additional costs | |
| | | assigned to SMS category for | |
| | | the current report cycle = D | |
| | | THEN applying 4. (Total count | |
| | | of work calls > Percentage) to | |
| | | D (total amount for data) = | |
| | | Total Data claim amount | |
| 26. | Other-claim | CALCULATE the total claim | |
| | amount (on | amount for data by | |
| | initial load calc) | SUM of all additional costs | |
| | | assigned to Other category for | |
| | | the current report cycle = O | |
| | | THEN applying 4. (Total count | |
| | | of work calls > Percentage) to | |
| | | O (total amount for other) = | |
| | | Total Other claim amount | |
| 27. | Total cycle cost | TRANSFER total cycle cost | |
| | | from total cost of current | |
| | | report cycle | |
| 28. | Claim amount | SUM the result of the | |
| | (current report | following calculations: | |
| | cycle) | 23 + 24 + 25 + 26 = Claim | |
| | | amount current report cycle | |
| 29. | Total claim | REPEAT algorithm steps 1-24 | Financial year dates may be stored |
| | amount | with consideration that the | within the database in a suitable form. |
| | (current | ‘current report cycle’ is | This ensures that the current financial |
| | financial year) | between 01 July YYYY | year may be displayed on the reports |
| | | 00:00:00 to 30 June 23:59:59 | page and the correct date span is used |
| | | | to calculate the claim figure for the |
| | | | current financial year. |
| | | | Given that the reporting page will load |
| | | | and calculate claim amounts based on |
| | | | the user's default setting, the total claim |
| | | | amount for the current financial year |
| | | | may be cached. |
| | | | Alternatively, a wide date span |
| | | | calculation may be made on the fly. |
| | | | It will be understood that the system |
| | | | would only need to re-calculate this |
| | | | figure on the fly if the user changes the |
| | | | calculation method |
| 30. | SMS-claim | CALCULATE the total claim | |
| | amount (on | amount for SMS by | |
| | change % calc) | SUM of all additional costs | |
| | | assigned to SMS category for | |
| | | the current report cycle = S | |
| | | THEN apply % set by the user | |
| | | to S (total amount for SMS) = | |
| | | Total SMS claim amount | |
| 31. | Data-claim | CALCULATE the total claim | |
| | amount (on | amount for SMS by | |
| | change % calc) | SUM of all additional costs | |
| | | assigned to SMS category for | |
| | | the current report cycle = S | |
| | | THEN apply % set by the user | |
| | | to S (total amount for SMS) = | |
| | | Total SMS claim amount | |
| 32. | Other-claim | CALCULATE the total claim | |
| | amount (on | amount for Other by | |
| | change % calc) | SUM of all additional costs | |
| | | assigned to Other category for | |
| | | the current report cycle = O | |
| | | THEN apply % set by the user | |
| | | to 0 (total amount for Other) = | |
| | | Total Other claim amount | |

TABLE 3
Algorithm for actual cost calculation method

| ID | Title | Description | Notes |
|---|---|---|---|
| 1 | Gather calls | FIND all calls within the date | Date range is specified as 00:00:00 |
| | | range of the currently selected | on a specific date to 23:59:59 on a |
| | | report cycle | specific date. |
| 3. | Calculate total | CALCULATE the total count of | |
| | count of calls with | calls tagged as work related | |
| | ‘work’ tag | | |
| 5. | Calculate the | CALCULATE the total count of | |
| | total count of | calls tagged as personal | |
| | calls with | related | |
| | ‘personal’ tag | | |
| 7. | Duration of work | CALCULATE the total duration | |
| | calls with actual | of work calls with an actual | |
| | costs | cost of more than $0.00 | |
| 8. | Duration of work | CALCULATE the total duration | |
| | calls with zero | of work calls with an actual of | |
| | actual cost | $0.00 | |
| 9. | Duration of | CALCULATE the total duration | |
| | personal calls | of personal calls with an actual | |
| | with actual costs | cost of greater than $0.00 | |
| 10. | Duration of | CALCULATE the total duration | |
| | personal calls | of personal calls with an actual | |
| | with zero actual | of $0.00 | |
| | cost | | |
| 11. | Duration of all | CALCULATE the duration of | |
| | work tagged calls | calls within the specified date | |
| | | range of the currently selected | |
| | | report cycle tagged as work | |
| 12 | Duration of all | CALCULATE the duration of | |
| | personal tagged | calls within the specified date | |
| | calls | range of the currently selected | |
| | | report cycle tagged as | |
| | | personal | |
| 13. | Count of costed | COUNT the number of calls | |
| | calls with work | within the specified date range | |
| | tag | of the currently selected report | |
| | | cycle | |
| | | AND tagged as work | |
| | | AND have an actual cost of | |
| | | greater than $0.00 | |
| 14 | Count of zero | COUNT the number of calls | |
| | cost calls with | within the specified date range | |
| | work tag | of the currently selected report | |
| | | cycle | |
| | | AND tagged as work | |
| | | AND have an actual cost of | |
| | | $0.00 | |
| 15. | Count of costed | COUNT the number of calls | |
| | calls with | within the specified date range | |
| | personal tag | of the currently selected report | |
| | | cycle | |
| | | AND tagged as personal | |
| | | AND have an actual cost of | |
| | | greater than $0.00 | |
| 16. | Count of zero | COUNT the number of calls | |
| | cost calls with | within the specified date range | |
| | personal tag | of the currently selected report | |
| | | cycle | |
| | | AND tagged as personal | |
| | | AND have an actual cost of | |
| | | $0.00 | |
| 17. | Total actual cost | CALCULATE the total actual | |
| | of costed work | cost of all calls tagged as work | |
| | calls | WHERE actual cost field is | |
| | | greater than $0.00 | |
| 18. | Total actual cost | CALCULATE the total actual | |
| | of costed | cost of all calls tagged as | |
| | personal calls | personal | |
| | | WHERE actual cost field is | |
| | | greater than $0.00 | |
| 19. | Calculate actual | CALCULATE total cost of zero | Scenario |
| | cost of zero cost | cost work calls for the current | Harry has a cap plan of $80. The |
| | work calls | report cycle by | report cycle Harry is currently |
| | | CONVERTING 7. (Duration of | reporting on shows that Harry spent |
| | | work calls with actual costs = | a total $95 on calls in the report |
| | | nc) into seconds | cycle. |
| | | e.g 04h15m39s or 04:15:39 | The total duration in seconds of work |
| | | becomes 15339 s (=ns) | calls for which Harry has an actual |
| | | THEN calculate per second | cost included is 15339 seconds |
| | | cost | In order to work out a per second call |
| | | 17. (Total actual cost of costed | cost for costed work calls, the |
| | | work calls = y)/7. (Duration of | system now divides the actual cost of |
| | | work calls with actual costs | costed work calls (which for Harry is |
| | | (expressed in second) = ns) = | $340) by the duration of work calls |
| | | per second call charge (ps) | with actual costs. |
| | | THEN convert 8. (Duration of | For this scenario the per second call |
| | | work calls with zero costs = nz) | cost is calculated at |
| | | into seconds | $0.0221657213638438 |
| | | e.g 09h25m12s or 09:25:12 | This per second call charge is then |
| | | becomes 33912 s | used to calculate the actual cost of |
| | | THEN calculate total actual | zero cost calls. |
| | | cost of zero cost work calls | If the system multiplies the per |
| | | ps (per second call charge) × | second call charge of |
| | | nz (duration of work calls with | $0.0221657213638438 by the |
| | | zero costs) | duration of work calls with zero |
| | | | costs, which is 33912 seconds then |
| | | | the system arrives at the actual cost |
| | | | for zero cost calls. |
| | | | Therefore, the cost for Harry's zero |
| | | | cost work calls is $751.68 (rounded |
| | | | to two decimal places) |
| 20. | Calculate actual | CALCULATE total cost of zero | Scenario |
| | cost of zero cost | cost personal calls for the | Harry has a cap plan of $80. The |
| | personal calls | current report cycle by: | report cycle Harry is currently |
| | | CONVERTING 9. (duration of | reporting on shows that Harry spent |
| | | personal calls with actual cost = | a total $95 on calls in the report |
| | | nc) into seconds | cycle. |
| | | e.g 10h6m22s or 10:06:22 | The total duration in seconds of |
| | | becomes 36382 s (=ns) | personal calls for which Harry has an |
| | | THEN calculate per second | actual cost included is 36382 |
| | | cost | seconds |
| | | 18. (Total actual cost of costed | In order to work out a per second call |
| | | personal calls = y)/7. | cost for costed personal calls, the |
| | | (Duration of personal calls with | system now divides the actual cost of |
| | | actual costs (expressed in | costed personal calls (which for |
| | | second) = ns) = | Harry is $220) by the duration of |
| | | per second call charge (ps) | work calls with actual costs. |
| | | THEN convert 10. (Duration of | For this scenario the per second call |
| | | personal calls with zero costs = | cost is calculated at |
| | | nz) into seconds | $0.0604727872457394 |
| | | e.g 4h16m5s or 04:16:05 | This per second call charge is then |
| | | becomes 15365 s | used to calculate the actual cost of |
| | | THEN calculate total actual | zero cost calls. |
| | | cost of zero cost personal calls | If the system multiplies the per |
| | | ps (per second call charge) × | second call charge of |
| | | nz (duration of personal calls | $0.0604727872457394 by the |
| | | with zero costs) | duration of work calls with zero |
| | | | costs, which is 15365 seconds then |
| | | | the system arrives at the actual cost |
| | | | for zero cost calls. |
| | | | Therefore, the cost for Harry's zero |
| | | | cost work calls is $929.16 (rounded |
| | | | to two decimal places) |
| 21. | Total actual cost | TOTAL the results of the | |
| | for work calls | following calculations | |
| | | 17. (Total actual cost of costed | |
| | | work calls) + 19. (Calculate | |
| | | actual cost of zero cost work | |
| | | calls) = Total actual cost for | |
| | | work calls | |
| 22. | Total actual cost | TOTAL the results of the | |
| | for personal calls | following calculations | |
| | | 18. (Total actual cost of costed | |
| | | personal calls) + 20. (Calculate | |
| | | actual cost of zero cost | |
| | | personal calls) = Total actual | |
| | | cost for personal calls | |
| 23 | Calls-claim | CALCULATE the total claim | |
| | amount | amount for calls by | |
| | | DEDUCTING total additional | |
| | | costs for SMS, Data and Other | |
| | | from total cost for current report | |
| | | cycle = C | |
| | | THEN applying percentage | |
| | | derived from calculation in 30. | |
| | | (Express total total actual cost | |
| | | for works calls as percentage of | |
| | | total actual cost.) to C (total | |
| | | amount for calls) = Total calls | |
| | | claim amount | |
| 24. | SMS-claim | CALCULATE the total claim | |
| | amount (on initial | amount for SMS by | |
| | load calc) | SUM of all additional costs | |
| | | assigned to SMS category for | |
| | | the current report cycle = S | |
| | | THEN apply percentage | |
| | | derived from calculation in 30. | |
| | | (Express total total actual cost | |
| | | for works calls as percentage of | |
| | | total actual cost.) to S (total | |
| | | amount for SMS) = Total SMS | |
| | | claim amount | |
| 25. | Data-claim | CALCULATE the total claim | |
| | amount (on initial | amount for data by | |
| | load calc) | SUM of all additional costs | |
| | | assigned to SMS category for | |
| | | the current report cycle = D | |
| | | THEN apply percentage | |
| | | derived from calculation in 30. | |
| | | (Express total actual cost for | |
| | | works calls as percentage of | |
| | | total actual cost.) to D (total | |
| | | amount for data) = Total Data | |
| | | claim amount | |
| 26. | Other-claim | CALCULATE the total claim | |
| | amount (on initial | amount for data by | |
| | load calc) | SUM of all additional costs | |
| | | assigned to Other category for | |
| | | the current report cycle = O | |
| | | THEN apply percentage | |
| | | derived from calculation in 30. | |
| | | (Express total actual cost for | |
| | | works calls as percentage of | |
| | | total actual cost.) to O (total | |
| | | amount for other) = Total Other | |
| | | claim amount | |
| 27. | Total cycle cost | TRANSFER total cycle cost | |
| | | from total cost of current report | |
| | | cycle | |
| 28. | Claim amount | SUM the result of the following | |
| | (current report | calculations: | |
| | cycle) | 23 + 24 + 25 + 26 = Claim | |
| | | amount current report cycle | |
| 29. | Total actual cost | ADD 21. + 22. to arrive at total | |
| | of all calls | actual cost for all calls | |
| 30. | Express total | CALCULATE (21.) the total | |
| | total actual cost | actual of work calls as a | |
| | for works calls as | percentage of (29.) the total | |
| | percentage of | actual cost (100%) for all calls | |
| | total actual cost. | with the date range of the | |
| | | current selected report cycle | |
| 31. | Express total | CALCULATE (22.) the total | |
| | total actual cost | actual of personal calls as a | |
| | for personal calls | percentage of (29.) the total | |
| | as percentage of | actual cost (100%) for all calls | |
| | total actual cost. | with the date range of the | |
| | | current selected report cycle | |
| 32. | Total claim | REPEAT algorithm steps 1-31 | Financial year dates may be stored |
| | amount (current | with consideration that the | within the database in a suitable |
| | financial year) | ‘current report cycle’ is between | form. |
| | | 01 July YYYY 00:00:00 to 30 | This ensures that the current |
| | | June 23:59:59 | financial year may be displayed on |
| | | | the reports page and the correct date |
| | | | span is used to calculate the claim |
| | | | figure for the current financial year. |
| | | | Given that the reporting page will |
| | | | load and calculate claim amounts |
| | | | based on the user's default setting, |
| | | | the total claim amount for the current |
| | | | financial year may be cached. |
| | | | Alternatively, a wide date span |
| | | | calculation may be made on the fly. |
| | | | It will be understood that the system |
| | | | would only need to re-calculate this |
| | | | figure on the fly if the user changes |
| | | | the calculation method |
| 33. | SMS-claim | CALCULATE the total claim | |
| | amount (on | amount for SMS by | |
| | change % calc) | SUM of all additional costs | |
| | | assigned to SMS category for | |
| | | the current report cycle = S | |
| | | THEN apply % set by the user | |
| | | to S (total amount for SMS) = | |
| | | Total SMS claim amount | |
| 34. | SMS-claim | CALCULATE the total claim | |
| | amount (on | amount for SMS by | |
| | change % calc) | SUM of all additional costs | |
| | | assigned to SMS category for | |
| | | the current report cycle = S | |
| | | THEN apply % set by the user | |
| | | to S (total amount for SMS) = | |
| | | Total SMS claim amount | |
| 35. | Other-claim | CALCULATE the total claim | |
| | amount (on | amount for Other by | |
| | change % calc) | SUM of all additional costs | |
| | | assigned to Other category for | |
| | | the current report cycle = O | |
| | | THEN apply % set by the user | |
| | | to O (total amount for Other) = | |
| | | Total Other claim amount | |

According to a further example, it will be understood that the portal may receive data from a different source for matching against the log data stored in the database, other than an uploaded PDF or CSV billing document from a telecommunications provider. For example, data from a Telecom Expense Management (TEM) system may be uploaded.

Many organisations manage a large number of mobile devices operated by their employees utilizing some form of TEM software. The portal as described herein is arranged to connect with the TEM software to extract call-related data in the form of an electronic file. This may be done, for example, on a monthly basis. The data in the electronic file may be sent from the TEM provider to the portal. This data is then downloaded or accessed by the portal and the data is extracted. The data then flows through the same process as described above in relation to the example where a user uploads billing data from a telecommunications provider. That is, the core data is transformed into a form usable by the system and then matched to existing call log records that were previously captured using the software application program executed on the mobile telephone and stored in the database.

Once this process has been completed, the results of the process are made visible via the portal to both the employer and employee within the organisation. The reports that are made available enable the employer to view work related calls made by the employee. That is, specific details of personal calls are not made visible to the employer. When generating the report, the system filters out call details associated with a telephone number having a “personal” tag associated with it. The employer is able to view the percentage of personal calls in order to determine the amount of work usage the employee is obtaining from the work-owned mobile telephone. This information may then be used by the employer to determine whether the employee should continue to be supplied with a work-owned mobile telephone.

An administrator of the system may calculate the employee contribution for personal related call usage during a specified month. This calculated value may then be used to deduct the relevant private-related portion of the plan cost for the employee's mobile telephone usage from the employee's salary. The administrator may also control which employees are able to access the service via the portal using an “admin portal” option. If an employee leaves the organisation, access to the portal may be suspended.

An organisation may create a corporate account via the webpage and the portal. This would enable the organisation to manage multiple company owned mobile assets and to assess payments that are to be made by employees that use their work telephones for private purposes. The company may purchase blocks of licences dependent on the number of employees that are using the company owned mobile telephones. One such licence may equate to a single employee managing a single company owned mobile device, for example.

Once the corporate account has been established details of mobile telephones owned by the company are uploaded via the portal. These details include telephone numbers and associated employee details. It will be understood that the different employees may be assigned to individual control groups depending upon their position within the organisation.

After the employee details have been entered and their telephone numbers have been registered via the portal, each employee is notified via SMS or email so that they can create their own account via the portal. Further, this notification will enable the employee to download the software application program on the mobile device. In addition, the employees may click on the link within the SMS or email notification in order to take them to a sign up page for corporate users of the service. After the employee has created an account using the corporate email address, the email addresses will be checked by the system against the list previously uploaded by the corporate account holder. After the list is verified, the system creates an account for the employee. A notification is then sent to the administrator in the company responsible for the service identifying all the employees that have signed up to the service. Subsequently, the software application program monitors and manages the call data in the same way as outlined in the various processes discussed herein.

It will be understood that all communication related data for all users associated with a corporate account may be stored in the database and accessed via the portal. This communication related data may then be analysed to determine which communication related data is associated with work related communications and so produce any suitable financial or usage report based on those work related communications.

The processor in the portal may analyse the communication related data to determine whether the data received from multiple telephones is to be associated with, and therefore tagged as, a work related communication.

For example, the system may use the list of work numbers in a corporation's call logs stored in the database to tag work numbers in user phones. This will effectively sync tagged work numbers in the logs with all users associated with that account to ensure those work numbers are correctly tagged. Syncing between the telephone and the backend system may be used. Alternatively, backend data may be sent to the telephone and syncing may occur locally.

This syncing may be performed using rules established by the corporate user. For example, the rules may define that if calls are made during normal work hours, the system determines that the associated contact details are work related details and so these details are given a higher weighting. Whereas, if the system determines that calls are made after work hours, the weighting associated with those communications may be changed given the nature of the business and job roles and/or department associated with the telephone user.

It will also be understood that the system may use analysis to determine whether to tag communication related data as work related data or not.

For example, if a single user calls and tags a number they may manually nominate that number to be added to the corporate directory. Alternatively, the system may count the number as a one off work call and not update the tag associated with that contact in the corporate directory stored in the database.

Whereas, if two separate devices (from different users) call the same number over a period and, based on a defined set of rules, the number is automatically forwarded to the backend management to be manually verified and potentially added to corporate directory as a work related contact. That is, the backend management manually tag the contact details (the number, contact name, email etc.) as a work related contact. The defined set of rules may be, for example, based on the time of day the call is made as well as the job function or hierarchy of the user,

Further, if two or more devices call a specific number under specified rules, the number and contact may be automatically added to the corporate directory as a work related contact independent of any manual interaction or approval.

It will be understood that any predefined trigger and set of rules may be used to determine when communication related data is to be used to assign a tag to a contact.

It will be understood that communication related data may be accessed from or provided by telecommunication providers to the database. This would then mean that the mobile telephones of the users are not required to upload the communication related data to the portal.

It will also be understood that the communication related data may be made available in CSV format either direct from the telephone call log or via the backend system portal.

It will also be understood that various other analysis on the communication related data may enable reports to be produced and tagging to occur based on one or more of: call length; average call duration; time of calls; plan usage (under or over).

This analysis may then enable the system to determine whether the current plan of a user (private or corporate) is suitable for that user based on their current communication related data, their current plan and available alternative plans. That is, for example, the system may make a comparison of total costs for a billing period for the user's existing plan and a number of other alternative plans and determine which of the plans produces the lowest cost in that billing period. The determined plan may then be communicated to the user.

Further, it will be understood that the system may record any expense that has been incurred as well as tax-related expenses. In particular, the expenses may be related to an amount that the user or corporation stands to be reimbursed.

It will also be understood that, instead of utilising a fixed billing period when calculating costs or claims, a flexible billing period or any other period may be used.

Also, it will be understood that by using the specific tagging action either work or personal calls may be identified automatically within a defined set of rules, and as such this enables the mobile device to determine whether a specific call (or SMS) is to be received or not received by the user. For example, if the user does not want to accept work calls outside of a defined work period, the call may be diverted to message based on the number being used to make the call being detected as a tagged work number. For example, the mobile device may enable the caller to be diverted or not after the device has checked the contact list and determined if a work or personal number respectively is coming in.

The same scenario as above may also be applied for personal calls being received during a defined work period or based on a set of defined rules.

It will also be understood that the mobile device and system may display, share or communicate any information relating to the communication related data or actions attributed to the electronic tagging of contacts or identities to other systems, including reporting and accounting systems.

For example, a regular plan may be used such as an $80 cap plan and work and personal costs may be automatically split using a pre-determined method as described herein (e.g. duration, time, bill upload etc.). The results may then be automatically uploaded to a further external system such as an enterprise application system (e.g. SAP™), enterprise resources planning system (e.g. Oracle™) or an online accounting system (e.g. Xero™). The results may also be collated to an extent where tax rebate claims are automatically sent through to taxation systems or software (e.g. MyTax™), or an accountant or bookkeeper.

Through the use of the herein described tagging mechanisms of contacts, the system enables key decisions to be made. For example, if in a work environment it has been determined that a more cost-effective or pre-determined method is available, the unique categorisation allows the most cost effective solution to be implemented. For example, it may be determined that work calls should be placed via a VOIP system or using a corporate communication plan.

Further, using the herein described tagging system allows reporting to be segregated and the privacy of personal calls to be preserved so that employee's personal calls are not made visible to the company.

According to certain embodiments, a system is provided that uses communication related data from multiple mobile telephones to autonomously learn employee behaviour for the purpose of automatically determining workplace expenses.

Various other aspects are disclosed according to the following clauses.

CLAUSE 1: A mobile communication device implemented method for tagging call related data, the method comprising the steps of: determining whether a call had been initiated on a mobile communication device; upon a positive determination that the call had been initiated, determining whether the call uses call related data that has not been previously used by the mobile communication device; and upon a positive determination, automatically applying an electronic tag to the call related data, wherein the electronic tag associates the call related data with a tax-related category selected from a plurality of tax-related categories.

CLAUSE 2: The method of clause 1 further comprising the step of storing the electronic tag that associates the call related data with the tax-related category.

CLAUSE 3: The method of clause 2, wherein the step of storing the electronic tag that associates the call related data with the tax-related category comprises the step of: communicating an association between the telephone number or contact and the tax-related category to an external database.

CLAUSE 4: The method of clause 2, wherein the step of storing the electronic tag that associates the call related data with the tax-related category comprises the step of: storing an association between the call related data and the tax-related category in a memory of the mobile communication device.

CLAUSE 5: The method of clause 1, wherein the electronic tag is associated with a pre-stored tax-related category that is pre-selected from the plurality of tax-related categories.

CLAUSE 6: The method of clause 5, wherein the pre-stored tax-related category is a user-defined tax-related category that was previously selected by a user of the mobile communication device.

CLAUSE 7: The method of clause 5, wherein the pre-stored tax-related category is a default-defined tax-related category that is stored within the mobile communication device.

CLAUSE 8: The method of clause 1 further comprising the steps of: displaying at least a portion of the call related data and associated tax-related category; displaying an interface to enable a user to modify the tax-related category; and upon detection that the user has modified the tax-related category, applying a further electronic tag to the telephone number, wherein the further electronic tag is associated with a further tax-related category selected from the plurality of tax-related categories.

CLAUSE 9: The method of clause 1 further comprising the step of: displaying a notification on a screen of the mobile communication device identifying at least a portion of the call related data and the associated tax-related category.

CLAUSE 10: The method of clause 1, wherein the step of determining whether the call uses call related data that has not been previously used further comprises the step of determining whether a telephone number is not currently associated with a contact that is stored in a memory of the mobile communication device.

CLAUSE 11: The method of clause 1, wherein the step of determining whether the call uses call related data that has not been previously used further comprises the step of determining whether a telephone number or contact has not previously been entered or stored into the mobile communication device.

CLAUSE 12: The method of clause 1, wherein the step of determining whether a call had been initiated further comprises the step of determining whether the call had been connected between the mobile communication device and a further mobile communication device for a pre-determined period of time.

CLAUSE 13: A mobile communication device comprising a processor arranged to: determine whether a call had been initiated on a mobile communication device; upon a positive determination that the call had been initiated, determine whether the call uses call related data that has not been previously used by the mobile communication device; and upon a positive determination, automatically apply an electronic tag to the call related data, wherein the electronic tag associates the call related data with a tax-related category selected from a plurality of tax-related categories.

CLAUSE 14: The mobile communication device of clause 13, wherein the processor is further arranged to store the electronic tag that associates the call related data with the tax-related category.

CLAUSE 15: The mobile communication device of clause 14, wherein the processor is further arranged to communicate an association between the call related data and the tax-related category to an external database.

CLAUSE 16: The mobile communication device of clause 14, wherein the processor is further arranged to store an association between the call related data and the tax-related category in a memory of the mobile communication device.

CLAUSE 17: The mobile communication device of clause 13, wherein the electronic tag is associated with a pre-stored tax-related category that is pre-selected from the plurality of tax-related categories.

CLAUSE 18: The mobile communication device of clause 17, wherein the pre-stored tax-related category is a user-defined tax-related category that was previously selected by a user of the mobile communication device.

CLAUSE 19: The mobile communication device of clause 17, wherein the pre-stored tax-related category is a default-defined tax-related category that is stored within the mobile communication device.

CLAUSE 20: The mobile communication device of clause 13 further comprising a display, wherein the processor is further arranged to: display at least a portion of the call related data and associated tax-related category on the display; display an interface to enable a user to modify the tax-related category on the display; and upon detect that the user has modified the tax-related category, apply a further electronic tag to the call related data, wherein the further electronic tag is associated with a further tax-related category selected from the plurality of tax-related categories.

CLAUSE 21: The mobile communication device of clause 13 further comprising a display, wherein the processor is further arranged to: display a notification on a screen of the mobile communication device identifying at least a portion of the call related data and the associated tax-related category

CLAUSE 22: The mobile communication device of clause 13, wherein the processor is further arranged to determine whether a telephone number is not currently associated with a contact that is stored in a memory of the mobile communication device.

CLAUSE 23: The mobile communication device of clause 13, wherein the processor is further arranged to determine whether a telephone number or contact has not previously been entered into the mobile communication device.

CLAUSE 24: The mobile communication device of clause 13, wherein the processor is further arranged to determine whether the call had been connected between the mobile communication device and a further mobile communication device for a pre-determined period of time.

CLAUSE 25: A computer implemented method comprising the steps of: retrieving plan data associated with a mobile communication device; retrieving call data that is associated with one or more calls made by the mobile communication device within a billing period; wherein the call data comprises tagged data, wherein the tagged data comprises one or more telephone numbers and/or contacts that were called within the billing period and one or more electronic tags associated with the telephone numbers and/or contacts; wherein the electronic tag associates the telephone numbers and/or contacts with a tax-related category selected from a plurality of tax-related categories; calculating a tax claimable value for the billing period value based on the plan data and the call data; and outputting the tax claimable value.

CLAUSE 26: The method of clause 25, wherein the call data further comprises call duration data and the step of calculating the tax claimable value further comprises the steps of: determining, using the call data, a first total duration value based on all calls made in the billing period; determining, using the call data, a second total duration value based on tagged data for the tax-related category; calculating the tax claimable value based on the first total duration value, second total duration value and the plan data.

CLAUSE 27: The method of clause 25, wherein the step of calculating the tax claimable value further comprises the steps of: determining, using the call data, a first total count value based on a number of all calls made in the billing period; determining, using the call data, a second total count value based on tagged data for the tax-related category; calculating the tax claimable value based on the first total count value, second total count value and the plan data.

CLAUSE 28: The method of clause 25 further comprising the steps of: extracting billing data from at least one electronic document or file that is associated with a billing period of the mobile communication device; matching the billing data to the call data to produce matched data; calculating actual cost data based on the matched data; and calculating a tax claimable value for the billing period value based on the actual cost data.

CLAUSE 29: A computing system comprising a communication interface for communicating with a mobile communication device, a database for storing plan data associated with the mobile communication device and a processor, wherein the communication interface is arranged to: retrieve plan data from the database, where the plan data is associated with a mobile communication device, retrieve call data from the database, where the call data is associated with one or more calls made by the mobile communication device within a billing period, wherein the call data comprises tagged data, where the tagged data comprises one or more telephone numbers and/or contacts that were called within the billing period, and one or more electronic tags associated with the telephone numbers and/or contacts, wherein the electronic tag associates the telephone numbers and/or contacts with a tax-related category selected from a plurality of tax-related categories; and the processor is arranged to calculate a tax claimable value for the billing period value based on the plan data and the call data, and output the tax claimable value.

CLAUSE 30: Software arranged to perform the method of any one of clauses 1 to 12.

CLAUSE 31: Software arranged to perform the method of any one of clauses 25 to 28.

CLAUSE 33: A non-transitory medium arranged to store the software in clause 30 or clause 31.

CLAUSE 34: A mobile communication device comprising a processor, communication interface, memory and display, wherein the memory comprises stored software code that is arranged to execute instructions under control of the processor to enable the processor to perform the method of any one of clauses 1 to 12 in conjunction with the communication interface and display.

### INDUSTRIAL APPLICABILITY

The arrangements described are applicable to the mobile telephone, computer and data processing industries.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

What is claimed is:

1. A mobile communication device implemented method for tagging mobile communication related data associated with a mobile communication device, wherein the mobile communication related data comprises one or more of: call related data, SMS related data, data usage related data and electronic mail related data, the method comprising the steps of the mobile communication device:
determining whether a communication had been initiated on the mobile communication device;
upon a positive determination by the mobile communication device that the communication had been initiated, determining, by searching log details stored on the mobile communication device, whether the communication uses telephone number or contact data that has not been previously used by the mobile communication device to initiate a previous communication using the mobile communication device; and
upon a positive determination by the mobile communication device that the communication uses telephone number or contact data that has not been previously used by the mobile communication device, automatically applying an electronic tag to the telephone number or contact data, wherein the electronic tag associates the telephone number or contact data with a tax-related category selected from a plurality of tax-related categories.

2. The method of claim 1 further comprising the step of storing the electronic tag that associates the telephone number or contact data with the tax-related category by communicating an association between the telephone number or contact and the tax-related category to an external database, or storing an association between the telephone number or contact data and the tax-related category in a memory of the mobile communication device.

3. The method of claim 1, wherein the electronic tag is associated with a pre-stored tax-related category that is pre-selected from the plurality of tax-related categories, wherein the pre-stored tax-related category is a user-defined tax-related category that was previously selected by a user of the mobile communication device, or a default-defined tax-related category that is stored within the mobile communication device.

4. The method of claim 1 further comprising the steps of:
displaying at least a portion of the telephone number or contact data and associated tax-related category;
displaying an interface to enable a user to modify the tax-related category; and
upon detection that the user has modified the tax-related category, applying a further electronic tag to the telephone number, wherein the further electronic tag is associated with a further tax-related category selected from the plurality of tax-related categories.

5. The method of claim 1, wherein the step of determining whether the call uses telephone number or contact data that has not been previously used further comprises the step of determining whether a telephone number is not currently associated with a contact that is stored in a memory of the mobile communication device, or whether a telephone number or contact has not previously been entered or stored into the mobile communication device.

6. The method of claim 1, wherein the step of determining whether the communication had been initiated comprises determining whether a call had been initiated, the method further comprises the step of determining whether the call had been connected between the mobile communication device and a further mobile communication device for a pre-determined period of time.

7. The method of claim 1, wherein the method further comprises the step of determining whether the electronic tag is to be applied based on analysis of the telephone number or contact data received from a plurality of mobile communication devices.

8. A mobile communication device comprising a processor arranged to:
determine whether a communication had been initiated on the mobile communication device;
upon a positive determination that the communication had been initiated, the processor of the mobile communication device being further arranged to determine, by searching log details stored on the mobile communication device, whether the communication uses telephone number or contact data that has not been previously used by the mobile communication device to initiate a previous communication using the mobile communication device, wherein the telephone number or contact data comprises one or more of: call related data, SMS related data, data usage related data and electronic mail related data; and
upon a positive determination, the processor of the mobile communication device being further arranged to automatically apply an electronic tag to the telephone number or contact data, wherein the electronic tag associates the telephone number or contact data with a tax-related category selected from a plurality of tax-related categories.

9. The mobile communication device of claim 8, wherein the processor is further arranged to store the electronic tag that associates the call related data with the tax-related category by communicating an association between the telephone number or contact data and the tax-related category to an external database or storing an association between the telephone number or contact data and the tax-related category in a memory of the mobile communication device.

10. The mobile communication device of claim 8, wherein the electronic tag is associated with a pre-stored tax-related category that is pre-selected from the plurality of tax-related categories, wherein the pre-stored tax-related category is a user-defined tax-related category that was previously selected by a user of the mobile communication device, or a default-defined tax-related category that is stored within the mobile communication device.

11. The mobile communication device of claim 8 further comprising a display, wherein the processor is further arranged to:
display at least a portion of the telephone number or contact data and associated tax-related category on the display;
display an interface to enable a user to modify the tax-related category on the display; and
upon detect that the user has modified the tax-related category, apply a further electronic tag to the telephone number or contact data, wherein the further electronic tag is associated with a further tax-related category selected from the plurality of tax-related categories.

12. The mobile communication device of claim 8, wherein the processor is further arranged to determine whether a telephone number is not currently associated with a contact that is stored in a memory of the mobile communication device, or whether a telephone number or contact has not previously been entered into the mobile communication device.

13. The mobile communication device of claim 8, wherein the determination of whether the communication had been initiated comprises determining whether a call had been initiated, and wherein the processor is further arranged to determine whether the call had been connected between the mobile communication device and a further mobile communication device for a pre-determined period of time.

14. A computer implemented method comprising the steps of:
retrieving telephone number or contact data that is associated with one or more communications made by at least one mobile communication device within a defined period, wherein the communication uses telephone number or contact data that the mobile communication device has determined by searching log details stored on the mobile communication device has not been previously used by the mobile communication device to initiate a previous communication using the mobile communication device;
wherein the telephone number or contact data comprises tagged data, wherein the tagged data comprises one or more telephone numbers and/or contacts that were communicated with within the defined period, SMS usage, data usage, and one or more associated electronic tags;
wherein the electronic tag associates the telephone numbers and/or contacts with the tagged data;
generating at least one financial report for the defined period based on the tagged data; and
outputting the generated financial report.

15. The method of claim 14, wherein the method further comprises the step of determining whether the electronic tag is to be applied based on analysis of the telephone number or contact data received from a plurality of mobile communication devices.

16. The method of claim 14, wherein the telephone number or contact data further comprises call duration data and the method further comprises the steps of calculating a tax claimable value by:
determining, using the call duration data, a first total duration value based on all calls made in the defined period;
determining, using the call duration data, a second total duration value based on tagged data for a tax-related category;
calculating the tax claimable value based on the first total duration value, second total duration value and plan data.

17. The method of claim 14, wherein the telephone number or contact data further comprises call duration data and the method further comprises the steps of calculating a tax claimable value by:
determining, using the call duration data, a first total count value based on a number of all calls made in the defined period;
determining, using the call duration data, a second total count value based on tagged data for a tax-related category;
calculating the tax claimable value based on the first total count value, second total count value and plan data.

18. The method of claim 14 further comprising the steps of:
extracting billing data from at least one electronic document or file that is associated with a defined period of the mobile communication device;
matching the billing data to the communication related data to produce matched data;
calculating actual cost data based on the matched data; and
calculating a tax claimable value for the defined period based on the actual cost data.

19. A computing system comprising a communication interface for communicating with at least one mobile communication device, a database for storing plan data associated with at least one mobile communication device and a processor, wherein the communication interface is arranged to:
retrieve telephone number or contact data from the database, where the telephone number or contact data is associated with one or more communications made by at least one mobile communication device within a defined period, wherein the communication uses telephone number or contact data that the mobile communication device has determined by searching log details stored on the mobile communication device has not been previously used by the mobile communication device to initiate a previous communication using the mobile communication device,
wherein the telephone number or contact data comprises tagged data, where the tagged data comprises one or more telephone numbers and/or contacts that were communicated with within the defined period, SMS usage, data usage, and one or more associated electronic tags,
wherein the electronic tag associates the telephone numbers and/or contacts with the tagged data and
the processor is arranged to at least one financial report for the defined period based on the tagged data, and
output the generated financial report.

20. The computing system of claim 19, wherein the processor is further arranged to determine whether the electronic tag is to be applied based on analysis of the communication related data received from a plurality of mobile communication devices.

21. Software arranged to perform the method of claim 1.

22. Software arranged to perform the method of claim 14.

23. A non-transitory medium arranged to store the software as claimed in claim 21.

24. A mobile communication device comprising a processor, communication interface, memory and display, wherein the memory comprises stored software code that is arranged to execute instructions under control of the processor to enable the processor to perform the method of claim 1 in conjunction with the communication interface and display.
